(19) United States
(12) Patent Application Publication
(10) Pub. No.: US 2011/0066801 A1
(43) Pub. Date: Mar. 17, 2011

(54) STORAGE SYSTEM AND METHOD FOR CONTROLLING THE SAME

(76) Inventor: Takahito Sato, Odawara (JP)

(21) Appl. No.: 12/375,611

(22) PCT Filed: Jan. 20, 2009
(86) PCT No.: PCT/JP2009/000182

§ 371 Date: Jan. 29, 2009

(51) Int. Cl. G06F 12/00

(52) U.S. Cl. 711/114; 711/E12.001

(57) ABSTRACT

A storage system in accordance with the present invention creates a virtual volume based on a remote copy pair and provides the virtual volume to a host. A first storage device and a second storage device share a locked disk in a third storage device. The information for controlling a usage of the virtual volume is stored into the locked disk. The virtual volume is created based on a remote copy pair composed of a primary volume and a secondary volume. A user can create and delete a virtual volume and a locked disk by issuing an instruction from a management server.

### TECHNICAL FIELD

The present invention relates to a storage system and a method for controlling the storage system.

### BACKGROUND ART

For instance, many companies control data using a comparatively large scale storage system to handle a large amount of data of many kinds. The storage system is provided with at least one storage control device. The storage control device is provided with a lot of storage devices, and provides a storage region based on the RAID (Redundant Array of Inexpensive Disks) for instance. At least one logical device (also called a logical volume) is created on a physical storage region that is provided by the storage device group. A host computer (hereafter referred to as a host) writes or reads data by issuing a write command or a read command to the logical device.

The storage system can store the same data into a plurality of logical devices to improve the security of data or the like. For instance, as a first conventional art, the storage system can store the same data into separate logical devices in one storage control device. In addition, the storage system can store the same data into the logical devices in separate storage control devices.

[Patent Citation 1]

JP-A-2007-150409

Moreover, as a second conventional art, it is also known that a pair of remote copies is created by the primary volume in one storage control device and the secondary volume in the other storage control device, and the two logical volumes that configure the remote copy are recognized by the host as the same device.

[Patent Citation 2]

JP-A-2008-134988

### DISCLOSURE OF INVENTION

### Technical Problem

For the above first conventional art, even in the case in which a primary logical device cannot be used, a work processing can be continues using a secondary logical device by storing data into a plurality of logical devices in the same package or by storing data into a plurality of logical devices located in separate packages. However, in the case in which a primary logical device is switched to a secondary logical device, it is necessary to purposefully switch an access destination device of the host from a primary logical device to a secondary logical device, thereby involving extra effort for a switching operation.

For the above second conventional art, since the primary volume and the secondary volume that configure the remote copy pair can be recognized by the host as the same logical volume, data can be controlled in a duplex manner. Moreover, the host can switch to the secondary volume to continue the information processing in the case in which a failure occurs. However, for the second conventional art, the host side must control whether each storage control device has a failure or not.

The present invention was made in consideration of the above problems, and an object of the present invention is to provide a storage system and a method for controlling the storage system in which separate logical volume devices that exist in separate storage control devices can be virtualized as one virtual volume, and the information for controlling the setting and usage of the virtual volume is stored into separate logical volume, whereby the consistency of a data access can be ensured. Other objects of the present invention will be clarified by the explanation of the modes described later.

### Technical Solution

To solve the above problems, a storage system in accordance with the first aspect of the present invention is a storage system provided with a host computer, a plurality of storage control devices that are used by the host computer, and a management device for managing the storage control devices, which are connected to each other so as to enable the communication with each other,

wherein the plurality of storage control devices include a first storage control device, a second storage control device, and a third storage control device, the storage system comprising a virtual volume setting section that creates a virtual volume that is provided to the host computer by setting a first volume included in the first storage control device and a second volume included in the second storage control device as a pair; and
a control volume setting section that sets a third volume included in the third storage control device as a control volume that stores the usage control information for controlling a usage of the virtual volume,
wherein the usage control information that is stored into the third volume includes the identification information for specifying the first storage control device and the second storage control device.

Viewed from a second aspect, the host computer is connected to the first storage control device and the second storage control device via a first communication path, the first storage control device and the second storage control device are connected to each other via a second communication path, the third storage control device is connected to the first storage control device and the second storage control device via a third communication path, the management device is connected to the host computer, the first storage control device, the second storage control device, and the third storage control device via a fourth communication path,
the first storage control device is provided with a first management section, the first volume, and a fourth volume virtually formed,
the second storage control device is provided with a second management section, the second volume, and a fifth volume virtually formed,
the management device is provided with:
(1) the virtual volume setting section that creates the virtual volume that is provided to the host computer by giving a prescribed instruction to the first management section and the second management section;
(2) the control volume setting section that sets the third volume as the control volume by giving another prescribed instruction to the first management section and the second management section; and
(3) a corresponding setting section that corresponds the fourth volume and the fifth volume to the third volume by giving other prescribed instruction to the first management section and the second management section,
the usage control information includes a third volume identification information for specifying the third volume, a first identification information for specifying the first storage control device, a second identification information for specifying the second storage control device, a first usage information for indicating whether the first storage control device uses the third volume or not, a second usage information for indicating whether the second storage control device uses the third volume or not, a first difference generation information for indicating that difference data is generated in the first volume after the pair is canceled, and a second difference generation information for indicating that difference data is generated in the second volume after the pair is canceled,
only the first storage control device can update the first identification information, the first usage information, and the first difference generation information,
only the second storage control device can update the second identification information, the second usage information, and the second difference generation information, and
only the first storage control device and the second storage control device that are corresponded to the usage control information can use the third volume, and other storage control device having identification information other than identification information included in the usage control information cannot use the third volume.

Viewed from a third aspect, the storage system in accordance with the first aspect further comprises a corresponding setting section that corresponds a virtual fourth volume formed in the first storage control device to the third volume and that corresponds a virtual fifth volume formed in the second storage control device to the third volume, wherein the first storage control device uses the third volume via the fourth volume, and the second storage control device uses the third volume via the fifth volume.

Viewed from a fourth aspect, for the storage system in accordance with the third aspect, only the first storage control device and the second storage control device can use the third volume, and other storage control devices having identification information other than identification information included in the usage control information cannot use the third volume.

Viewed from a fifth aspect, for the storage system in accordance with the first aspect, the virtual volume setting section and the control volume setting section are disposed in the management device.

Viewed from a sixth aspect, for the storage system in accordance with the third aspect, the virtual volume setting section, the control volume setting section, and the corresponding setting section are disposed in the management device.

Viewed from a seventh aspect, for the storage system in accordance with the first aspect, the usage control information includes a region that can be updated by only the first storage control device and a region that can be updated by only the second storage control device.

Viewed from an eighth aspect, for the storage system in accordance with the first aspect, the usage control information includes a third volume identification information for specifying the third volume, a first identification information for specifying the first storage control device, a second identification information for specifying the second storage control device, a first usage information for indicating whether the first storage control device uses the third volume or not, a second usage information for indicating whether the second storage control device uses the third volume or not, a first difference generation information for indicating that difference data is generated in the first volume after the pair is canceled, and a second difference generation information for indicating that difference data is generated in the second volume after the pair is canceled,

Viewed from a ninth aspect, for the storage system in accordance with the eighth aspect, only the first storage control device can update the first identification information, the first usage information, and the first difference generation information, and only the second storage control device can update the second identification information, the second usage information, and the second difference generation information.

Viewed from a tenth aspect, for the storage system in accordance with the first aspect, in the case in which the usage control information is updated, the usage control information is read from the third volume to confirm whether the usage control information is updated correctly or not.

Viewed from an eleventh aspect, for the storage system in accordance with the first aspect, the first storage control device is provided with a first management table corresponding to the usage control information, the second storage control device is provided with a second management table corresponding to the usage control information, and the first management table and the second management table are updated corresponding to the update of the usage control information.

Viewed from a twelfth aspect, for the storage system in accordance with the first aspect, in the case in which a difference is generated between the first volume and the second volume, the virtual volume setting section resynchronizes the storage content of the first volume and the storage content of the second volume so as to cancel the difference based on a prescribed opportunity.

Viewed from a thirteenth aspect, for the storage system in accordance with the first aspect, in the case in which the pair related to the virtual volume is deleted, the control volume setting section deletes the usage control information related to the virtual volume after the virtual volume setting section deletes the pair.

A method for controlling a storage system in accordance with the fourteenth aspect of the present invention is a method for controlling a storage system provided with a host computer, a plurality of storage control devices that are used by the host computer, and a management device for managing the storage control devices, which are connected to each other so as to enable the communication with each other,
wherein the plurality of storage control devices include a first storage control device, a second storage control device, and a third storage control device,
the method for controlling the storage system comprising the steps of:
creating a virtual volume that is provided to the host computer by setting a first volume included in the first storage control device and a second volume included in the second storage control device as a pair;
setting a third volume included in the third storage control device as a control volume that stores the usage control information for controlling a usage of the virtual volume; and
including the identification information for specifying the first storage control device and the second storage control device in the usage control information that is stored into the third volume,
wherein the steps are executed based on an instruction that is sent from the management device to the first storage control device and the second storage control device.

The whole or part of means, functions, and steps in accordance with the present invention can be configured as a computer program that is executed by a computer system in some cases. In the case in which the whole or part of the configurations in accordance with the present invention is configured with a computer program, the computer program can be stored into various kinds of storage media for a distribution, and can be transmitted via a communication network.

The aspects of various kinds other than expressed in accordance with the present invention can be combined with each other, and such combinations are included in the scope of the present invention.

### BRIEF DESCRIPTION OF DRAWINGS

FIG. 1 is a schematic view showing an embodiment in accordance with the present invention.

FIG. 2 is a hardware configuration diagram of a storage system in accordance with an embodiment of the present invention.

FIG. 3 is an illustration diagram schematically showing a software configuration of a host and a management server.

FIG. 4 is an illustration diagram showing a storage hierarchical structure of a storage device.

FIG. 5 is an illustration diagram showing a configuration example of a virtual volume.

FIG. 6 is an illustration diagram showing a table for managing a lock disk.

FIG. 7 is an illustration diagram schematically showing a configuration of a lock information bit map.

FIG. 8 is an illustration diagram showing a configuration of the usage control information.

FIG. 9 is an illustration diagram showing a table for managing a remote copy pair that configures a virtual volume.

FIG. 10 is an illustration diagram showing a table for managing a logical volume.

FIG. 11 is an illustration diagram showing a table for managing an external volume.

FIG. 12 is an illustration diagram showing a lock disk management window.

FIG. 13 is a flowchart showing a processing for creating a lock disk that is carried out by a first storage device.

FIG. 14 is a flowchart showing a processing for creating a lock disk that is carried out by a second storage device.

FIG. 15 is an illustration diagram showing a lock disk management window in creating a lock disk.

FIG. 16 is an illustration diagram showing a lock disk management table in creating a lock disk.

FIG. 17 is an illustration diagram showing a remote copy management window.

FIG. 18 is an illustration diagram showing the content of a menu in accordance with a remote copy pair.

FIG. 19 is an illustration diagram showing a window for creating a remote copy pair.

FIG. 20 is a flowchart showing a processing for creating a virtual volume based on a remote copy pair.

FIG. 21 is an illustration diagram showing a remote copy management window in creating a virtual volume.

FIG. 22 is an illustration diagram showing a pair management table T20 in creating a virtual volume.

FIG. 23 is an illustration diagram showing a lock disk management window in the case in which a plurality of lock disks is created.

FIG. 24 is an illustration diagram showing a remote copy management window in the case in which a plurality of virtual volumes is corresponded to one lock disk.

FIG. 25 is an illustration diagram showing a lock disk management table in the case in which a plurality of lock disks is created.

FIG. 26 is an illustration diagram showing a pair management table.

FIG. 27 is a flowchart showing a processing for updating a lock disk.

FIG. 28 is a flowchart showing a read processing for reading data from a primary volume of a first storage device.

FIG. 29 is a flowchart showing a read processing for reading data from a secondary volume of a second storage device.

FIG. 30 is a flowchart showing a write processing for writing data to a primary volume of a first storage device.

FIG. 31 is a flowchart showing a write processing for writing data to a secondary volume of a second storage device.

FIG. 32 is a flowchart showing a case in which a processing for writing data to a secondary volume of a second storage device fails.

FIG. 33 is a flowchart showing a processing for deleting a virtual volume.

FIG. 34 is a flowchart showing a processing for deleting a lock disk.

FIG. 35 is a flowchart showing a case in which a problem occurs for a deletion of a lock disk.

FIG. 36 is a flowchart showing a processing for deleting a lock disk by using a reserve command.

FIG. 37 is a flowchart showing a processing for deleting a lock disk and deleting a virtual volume in conjunction with each other.

FIG. 38 is a flowchart showing a processing for migrating to a suspend status.

FIG. 39 is a flowchart showing a re-synch processing.

FIG. 40 is a flowchart that shows a processing for a migration to a swap suspend status.

FIG. 41 is a flowchart showing a reverse re-synch processing.

FIG. 42 is a flowchart showing an automatic reverse re-synch processing.

### EXPLANATION OF REFERENCE

1, 2, and 3: Storage devices
1A and 2A: Logical volumes
1B and 2B: Logical volumes
3A: Lock disk
4: Management server
4A: Virtual volume setting section
4B: Lock disk setting section
4C: External connection setting section
5: Host
6: Virtual volume
10, 20, and 30: Storage devices
70: Host
80: Management server
100: Controller
140: Shared memory
160: Service processor
231: Virtual volume
232: Lock disk
L10: Usage control information

### BEST MODE FOR CARRYING OUT THE INVENTION

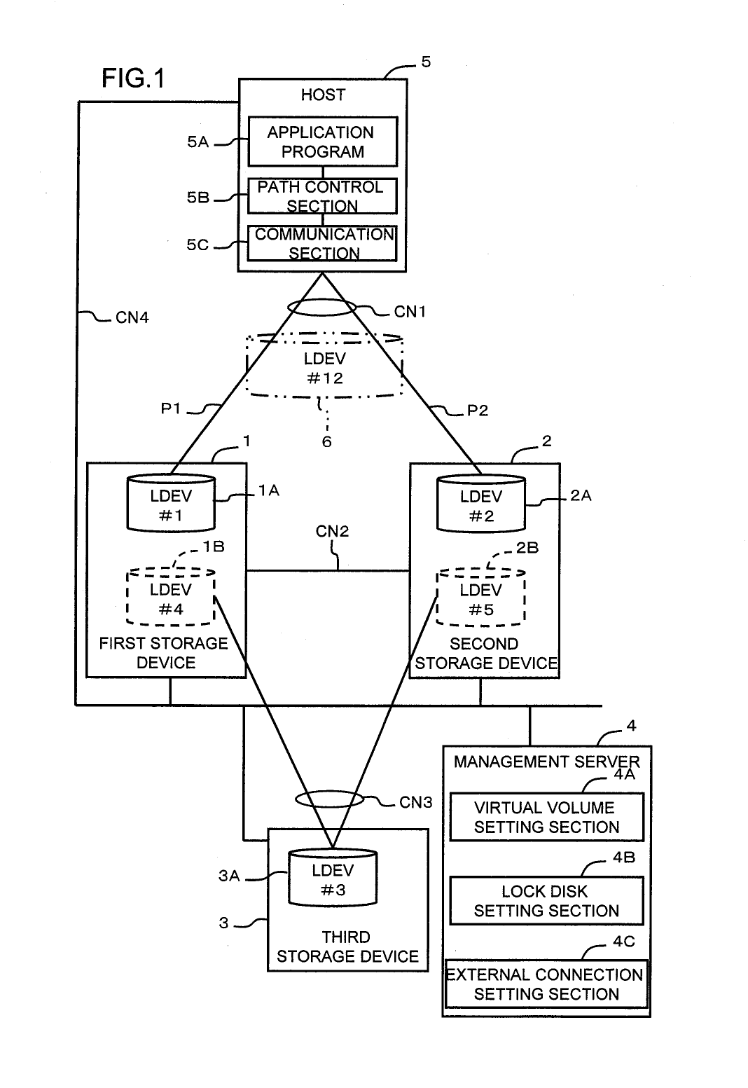

FIG. 1 is a configuration illustration diagram showing an overall outline of an embodiment in accordance with the present invention. As described later, the embodiment in accordance with the present invention discloses a configuration in which the logical volumes 1A and 2A in separate storage devices 1 and 2 form one virtual volume 6, a configuration in which the logical volumes 1B and 2B formed virtually are connected to the logical volume 3A in separate storage device 3, and a configuration in which the logical volume 3A is used as a lock disk that stores information for controlling a usage of the virtual volume 6.

The storage system virtualizes the logical volumes 1A and 2A that exist in separate storage devices 1 and 2 to create the virtual volume 6, and provides the virtual volume 6 to a host 5. The same device identification information (LUN: Logical Unit Number) is set to each of the logical volumes 1A and 2A. Consequently, the host 5 cannot distinguish between the logical volumes 1A and 2A. To be precise, the device identification information of the primary volume 1A is set to the secondary volume 2A.

The logical volumes 1A and 2A configure a pair of remote copies, and the logical volume 1A is a primary volume and the logical volume 2A is a secondary volume for instance. Data that has been written to the primary volume 1A is transmitted and written to the secondary volume 2A. Even in the case in which a failure occurs to any one of the primary volume 1A and the secondary volume 2A, data input/output can be carried out by using a normal volume.

A lock disk 3A stores information that indicates which of the primary volume 1A and the secondary volume 2A has generated a difference. The storage devices 1 and 2 share the lock disk 3A, and operates the virtual volume 6 based on the information (the usage control information) that has been stored into the lock disk 3A.

Consequently, in the embodiment in accordance with the present invention, the host 5 can be prevented from accessing old data in the case in which a failure or the like occurs. Moreover, in the embodiment in accordance with the present invention, the setting of the virtual volume 6 and the setting of the lock disk 3A can be carried out by an operation from a management server 4.

The storage system shown in FIG. 1 will be described below. The storage system is provided with the storage devices 1, 2, and 3 as a storage control device, the management server 4 as a management device, and the host 5 as a host computer.

At first, a connection configuration will be described. The first storage device 1 and the second storage device 2 are connected to the host 5 via a first communication network CN1 as a first communication path. Moreover, the first storage device 1 and the second storage device 2 are connected to each other via a second communication path CN2.

The first storage device 1 and the second storage device 2 are connected to the third storage device 3 via a third communication network CN1 as a third communication path. The management server 4 is connected to the storage devices 1, 2, and 3 and the host 5 via a fourth communication network CN4 as a fourth communication path.

For instance, the communication networks CN1 and CN3 can be configured by using FC_SAN (Fibre Channel_Storage region Network) or IP_SAN (Internet Protocol_SAN) or the like. For instance, the fourth communication network CN4 can be configured by using LAN (Local Area Network) or WAN (Wide Area Network) or the like. For instance, the second communication path CN2 can be configured by using an FC protocol and a fiber cable or a metal cable that directly connect between the storage devices 1 and 2. The above configurations are explained as an example, and the present invention is not restricted to the above connection configurations. Moreover, the present invention is not restricted to the wire line connection, and a data communication can also be enabled by a wireless connection.

The storage devices 1, 2, and 3 are configured as physically different devices, are provided with logical volumes 1A, 2A, and 3A, respectively. The storage devices 1, 2, and 3 can be provided with a plurality of storage devices, and a logical volume as a logical device is formed on a physical storage region included in the storage device. For instance, the logical volumes 1A, 2A, and 3A can be formed on a redundant physical storage region such as RAID5 and RAID6. In the following descriptions, a logical volume is referred to as a volume in some cases. In the figures, a logical volume as a logical device is shown as LDEV.

As a storage device, devices of a variety of kinds that can read/write data such as a hard disk device, a semiconductor memory device, an optical disk device, a magnetic optical disk device, a magnetic tape device, and a flexible disk device can be utilized for instance.

In the case in which a hard disk device is used as a storage device, a disk such as an FC (Fibre Channel) disk, an SCSI (Small Computer System Interface) disk, a SATA disk, an ATA (AT Attachment) disk, and a SAS (Serial Attached SCSI) disk can be used for instance.

In the case in which a semiconductor memory device is used as a storage device, a memory device such as a flash memory, an FeRAM (Ferroelectric Random Access Memory), an MRAM (Magnetoresistive Random Access Memory), a phase change memory (Ovonic Unified Memory), and an RRAM (Resistance RAM) can be used for instance. A kind of a storage device is not restricted to the above devices, and storage devices of other kinds that will be a commercial reality in the future can also be utilized.

FIG. 1 shows the case in which the storage devices 1, 2, and 3 are provided with real logical volumes 1A, 2A, and 3A, respectively. The real logical volume is a volume that is directly corresponded to a physical storage region of a storage device. The first storage device 1 and the second storage device 2 can retrieve and use the logical volume 3A included in the external third storage device 3. The technique for retrieving the logical volume 3A included in the external storage device 3 into the device itself and for using the logical volume as a real logical volume of its own is disclosed in Japanese Patent Application Laid-Open Publication No. 2005-107645. The technique disclosed in the publication can be incorporated in the embodiment in accordance with the present invention.

Consequently, the first storage device 1 and the second storage device 2 can also have a configuration that is not provided with a storage device such as a hard disk drive. In this case, the first storage device 1 and the second storage device 2 can be configured as a computer device such as a switching device and a virtualization device.

The management server 4 is a device for managing the configurations of the storage devices 1, 2, and 3 and for giving an instruction to the host 5. The management server 4 is provided with a virtual volume setting section 4A, a lock disk setting section 4B as a control volume setting section, and an external connection setting section 4C as a corresponding setting section in addition to a basic function for managing the storage system.

The virtual volume setting section 4A is a function for virtualizing the logical volumes 1A and 2A that exist in separate storage devices 1 and 2, respectively, to create a virtual volume 6 and for providing the virtual volume 6 to the host 5. The virtual volume 6 can also be called a remote copy pair type virtual volume for instance.

The lock disk setting section 4B is a function for carrying out the setting for using the logical volume 3A in the third storage device 3 as a lock disk. As a matter of practical convenience, the logical volume 3A is referred to as a lock disk 3A in some cases in the following. The usage control information that is referred to for using the virtual volume 6 is stored into the lock disk 3A.

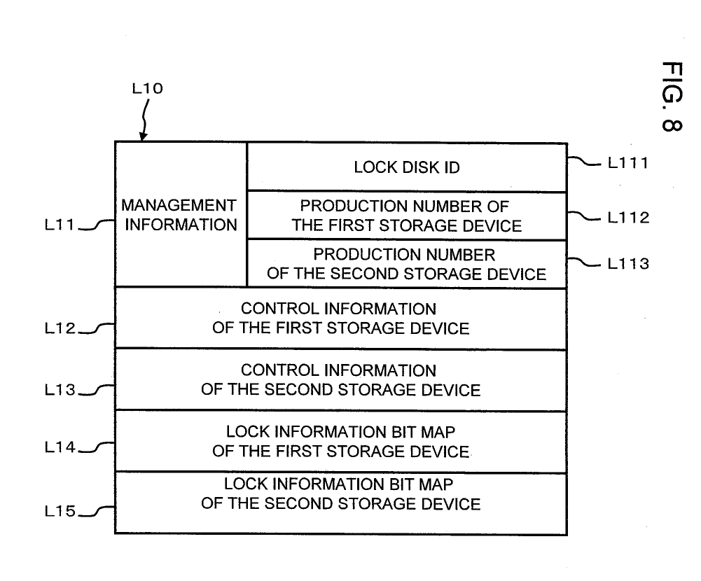

As described later in FIG. 8, the usage control information includes the identification information for specifying the lock disk 3A, the identification information for specifying the first storage device 1, the identification information for specifying the second storage device 2, the information that indicates whether the first storage device 1 uses the lock disk 3A or not, the information that indicates whether the second storage device 2 uses the lock disk 3A or not, the information for indicating that difference data is generated in the first volume 1A after the remote copy pair is canceled, and the information for indicating that difference data is generated in the second volume 2A after the remote copy pair is canceled.

The external connection setting section 4C makes the volume 1B in the first storage device 1 and the lock disk 3A in the third storage device 3 correspond to each other, and makes the volume 2B in the second storage device 2 and the lock disk 3A in the third storage device 3 correspond to each other. The first storage device 1 accesses the lock disk 3A via the volume 1B in the device itself. Similarly, the second storage device 2 accesses the lock disk 3A via the volume 2B in the device itself. A command related to the volume 1B is converted into a command to the external lock disk 3A, and is transmitted from the first storage device 1 to the third storage device 3. Similarly, a command related to the volume 2B is converted into a command to the external lock disk 3A, and is transmitted from the second storage device 2 to the third storage device 3.

For instance, the host 5 is configured as a computer device such as a mainframe computer, a server computer, an engineering workstation, and a personal computer. In the case in which the host 5 is a mainframe computer, a communication protocol such as FICON (Fibre Connection: registered trademark), ESCON (Enterprise System Connection: registered trademark), ACONARC (Advanced Connection Architecture: registered trademark), and FIBARC (Fibre Connection Architecture: registered trademark) is used for instance. In the case in which the host 5 is a server computer or a personal computer or the like, a communication protocol such as TCP/IP (Transmission Control Protocol/Internet Protocol), FCP (Fibre Channel Protocol), and iSCSI (internet Small Computer System Interface) is used for instance.

For instance, the host 5 is provided with an application program (hereafter referred to as an application in some cases) 5A, a path control section 5B, and a communication section 5C. The hardware configurations of the storage devices 1, 2, and 3, the management server 4, and the host 5 will be described later in an embodiment. The application program 5A is one or a plurality of software products for carrying out a variety of operations such as the electronic mail management software, the customer management software, and the document preparation software.

The path control section 5B is software that is used by the host 5 switching an access path (hereafter referred to as a path in some cases). The host 5 is connected to the logical volume 1A in the first storage device 1 via one path P1. The host 5 is connected to the logical volume 2A in the second storage device 2 via the other path P2.

In a normal case, one path P1 is an active path, and the other path P2 is a passive path. In the case in which the path control section 5B cannot access the virtual volume 6 using the active path P1, the path control section 5B switches the active path P1 to the passive path P2 to access the virtual volume 6.

The host 5 can obtain an identifier, a device number, an LU number, and path information of each of the logical volumes 1A and 2A formed in each of the storage devices 1 and 2 by transmitting a query command such as an Inquiry command to each of the storage devices 1 and 2. In the case in which a plurality of paths having the same identifier is detected, the path control section 5B recognizes the plurality of paths as a switch path.

In other words, in the case in which a plurality of paths for accessing the same virtual volume 6 is detected, the path control section 5B recognizes one path P1 as an active path (also called a primary path) that is used in a normal case, and recognizes the other path P2 as a passive path (also called a secondary path) that is used in an abnormal case.

The virtual volume 6 is configured by virtualizing the logical volumes 1A and 2A that exist in separate storage devices 1 and 2, respectively. The virtual volume 6 is created by the virtual volume setting section 4A giving an instruction to the storage devices 1 and 2. The logical volumes 1A and 2A that configure the virtual volume 6 can be called as a component volume for instance.

The logical volume 1A is set as the primary volume in the virtual volume 6, and the logical volume 2A is set as the secondary volume in the virtual volume 6. However, as clarified in an embodiment described later, the primary volume and the secondary volume are switched as needed. In the case in which an access failure occurs in the logical volume 1A, an attribute of the logical volume 2A is switched from the secondary volume to the primary volume. In the case in which an attribute of the logical volume 2A is switched to the primary volume, the device identification information that has been set to the logical volume 2A is held without modification. This is because in the case in which the device identification information of the logical volume 2A is changed to a value different from the device identification information of the logical volume 1A, the host 5 identifies it as another logical volume.

The primary volume is a volume that is accessed from the host 5 in a normal case, and the secondary volume is a volume that is accessed from the host 5 in the case in which a failure occurs. Consequently, the primary volume can also be called an active volume, and the secondary volume can also be called a passive volume. In the case in which the primary volume and the secondary volume that configure the virtual volume 6 form a copy pair, the primary volume can also be called a copy source volume, and the secondary volume can also be called a copy destination volume.

An identifier for uniquely specifying the virtual volume 6 in the storage system is set to the virtual volume 6. In the example shown in FIG. 1, #12 as an identifier is set to the virtual volume 6.

An identifier that is set to the virtual volume 6 is created based on the original identifier of each of the logical volumes 1A and 2A that configure the virtual volume 6. In the example shown in FIG. 1, the original identifier of one logical volume 1A is #1, and the original identifier of the other logical volume 2A is #2. The identifier #12, which is obtained by making the identifier #1 of one logical volume 1A and the identifier #2 of the other logical volume 2A unite with each other, is set to the virtual volume 6. An identifier that is set to the virtual volume 6 is created in such a manner that the identifier does not overlap with an identifier of each of other logical volumes that exist in the storage system.

In the case in which the virtual volume 6 is set, the storage devices 1 and 2 set an identifier equal to the identifier #12 of the virtual volume 6 to the logical volumes 1A and 2A that configure the virtual volume 6. In other words, the first storage device 1 sets the identifier #12 as an identifier of the logical volume 1A, and the second storage device 2 sets the identifier #12 as an identifier of the logical volume 2A. The identifier #12 can be called a virtual identifier for specifying the virtual volume 6.

The virtual identifier #12 is set prior to the original identifiers #1 and #2 of each of the logical volumes 1A and 2A that configure the virtual volume 6. Consequently, to an inquiry from the host 5, the first storage device 1 returns the virtual identifier #12 as an identifier of the logical volume 1A, and the second storage device 2 returns the virtual identifier #12 as an identifier of the logical volume 2A. Therefore, the path control section 5B recognizes the logical volume 1A and the logical volume 2A as the same volume (the virtual volume 6).

The original identifiers #1 and #2 set to each of the logical volumes 1A and 2A are internal identification information that is used for managing the logical volumes 1A and 2A in the storage devices 1 and 2. On the other hand, the virtual identifier #12 is external identification information for making the host 5 recognize the virtual volume 6.

The path P1 for accessing the logical volume 1A and the path P2 for accessing the logical volume 2A are recognized by the path control section 5B as a path for accessing the virtual volume 6.

The operation of the present storage system will be described. At first, a user makes the logical volume 3A in the third storage device 3, the virtual logical volume 1B in the first storage device 1, and the virtual logical volume 2B in the second storage device 2 correspond to each other by using the external connection setting section 4C.

Next, a user sets the logical volume 3A in the third storage device 3 as the lock disk 3A for controlling a usage of the virtual volume 6 by using the lock disk setting section 4B.

Moreover, a user specifies the logical volumes 1A and 2A that configure the virtual volume 6 by using the virtual volume setting section 4A, and sets the relationship between the logical volumes 1A and 2A and the lock disk 3A.

In the case in which the application program 5A writes data into the virtual volume 6, the path control section 5B issues a write command to the logical volume 1A by using the active path P1.

The first storage device 1 writes the write data that has been received from the host 5 to the logical volume 1A. In addition, the first storage device 1 transmits the write data to the logical volume 2A that configures the virtual volume 6 with the logical volume 1A via the communication path CN2.

The second storage device 2 writes the write data that has been received from the first storage device 1 to the logical volume 2A. As described above, the storage devices 1 and 2 that provide the virtual volume 6 write the write data to the logical volumes 1A and 2A, respectively. Consequently, in a normal case, the logical volumes 1A and 2A that configure the virtual volume 6 have the equal storage contents.

In the case in which a failure occurs in the second storage device 2 or the communication path CN2 that connects the first storage device 1 and the second storage device 2 to each other is disconnected, the storage system provides the virtual volume 6 to the host 5 by using the first storage device 1 without stopping the operation.

In the case in which the operation of the storage system is continued, new data is stored in the logical volume 1A of the first storage device 1, and a difference is generated between the storage content of the logical volume 2A and the storage content of the logical volume 1A. The first storage device 1 writes an event that a difference is generated for the logical volume 1A into the usage control information in the lock disk 3A.

In the case in which the second storage device 2 is restored from the failure or the communication path CN2 that connects the first storage device 1 and the second storage device 2 to each other is returned to the normal status, the difference data that has been stored in the logical volume 1A (the primary volume) is transmitted to the logical volume 2A (the secondary volume). Consequently, the storage content of the primary volume 1A and the storage content of the secondary volume 2A are synchronized with each other.

In the case in which the host 5 tries to access the logical volume 2A, the second storage device 2 refers to the usage control information in the lock disk 3A. The usage control information stores events such as that the volumes 1A and 2A are not synchronized with each other and that the virtual volume 6 is operated using the logical volume 1A. Consequently, the second storage device 2 returns an error to the host 5 without responding to the access from the host 5. By this, the host 5 can be prevented from accessing old data.

On the other hand, it is similar in the case in which a failure occurs in the first storage device 1 and the second storage device 2 operates the virtual volume 6 by using the logical volume 2A. In this case, the difference data is stored in the logical volume 2A. The usage control information stores events such as that the difference data is stored in the logical volume 2A and that the virtual volume 6 is operated using the logical volume 2A. The first storage device 1 that does not obtain an initiative related to the virtual volume 6 does not correspond to an access from the host 5. Consequently, the host 5 can be prevented from accessing old data (data in the logical volume 1A).

The embodiment in accordance with the present invention that is configured as described above has the following effects. In the embodiment in accordance with the present invention, the lock disk 3A is formed in the third storage device 3 that is separate from the first storage device 1 and the second storage device 2, and the usage control information for controlling a usage of the virtual volume 6 that is configured by the logical volume 1A and the logical volume 2A is stored into the lock disk 3A. Consequently, the storage devices 1 and 2 can appropriately carry out a switch between the storage devices 1 and 2 by sharing the lock disk 3A. Therefore, it is not necessary for the host 5 to be conscious of a switch between the storage devices 1 and 2.

In the embodiment in accordance with the present invention, the usage control information includes the identification information for specifying the first storage device 1 and the second storage device 2. By this, a failure in which the lock disk 3A is associated with other storage device can be prevented from occurring.

In the embodiment in accordance with the present invention, the lock disk 3A is corresponded to the logical volumes 1B and 2B that are formed virtually in the storage devices 1 and 2, and the lock disk 3A is used via the logical volumes 1B and 2B. Consequently, the lock disk 3A can be accessed by using an amount of cache memory and a function in the storage devices 1 and 2.

In the embodiment in accordance with the present invention, the management server 4 is provided with a virtual volume setting section 4A, a lock disk setting section 4B, and an external connection setting section 4C. Consequently, a user can carry out the creation and deletion of the virtual volume 6, the creation and corresponding of the lock disk 3A, and a connection between the logical volumes 1B and 2B and the lock disk 3A, for instance, by using the setting sections 4A to 4C of the management server 4, thereby improving usability.

As described later in an embodiment, only the first storage device 1 can update the information for identifying the first storage device 1, the information for indicating that the first storage device 1 uses the lock disk 3A, and the information for indicating that difference data is generated in the logical volume 1A among each of information included in the usage control information. Similarly, only the second storage device 2 can update the information for identifying the second storage device 2, the information for indicating that the second storage device 2 uses the lock disk 3A, and the information for indicating that difference data is generated in the logical volume 2A among each of information included in the usage control information. Consequently, it can be prevented from occurring that the first storage device 1 rewrites the information related to the second storage device 2 by mistake, and in reverse, that the second storage device 2 rewrites the information related to the first storage device 1 by mistake, thereby improving reliability.

Moreover, as clarified in an embodiment described later, in the case in which the usage control information is updated, the usage control information is read from the lock disk 3A after the update, and it is confirmed whether the usage control information has been updated correctly or not. Consequently, even in the case in which the separate storage devices 1 and 2 share one lock disk 3A, it can be ensured that the usage control information is updated appropriately, thereby improving the reliability of the storage system.

Furthermore, as clarified in an embodiment described later, in the case in which the lock disk is deleted, a virtual volume can also be deleted by one direction. By this, usability can be improved. The embodiment in accordance with the present invention will be described in detail in the following.

### Embodiment 1

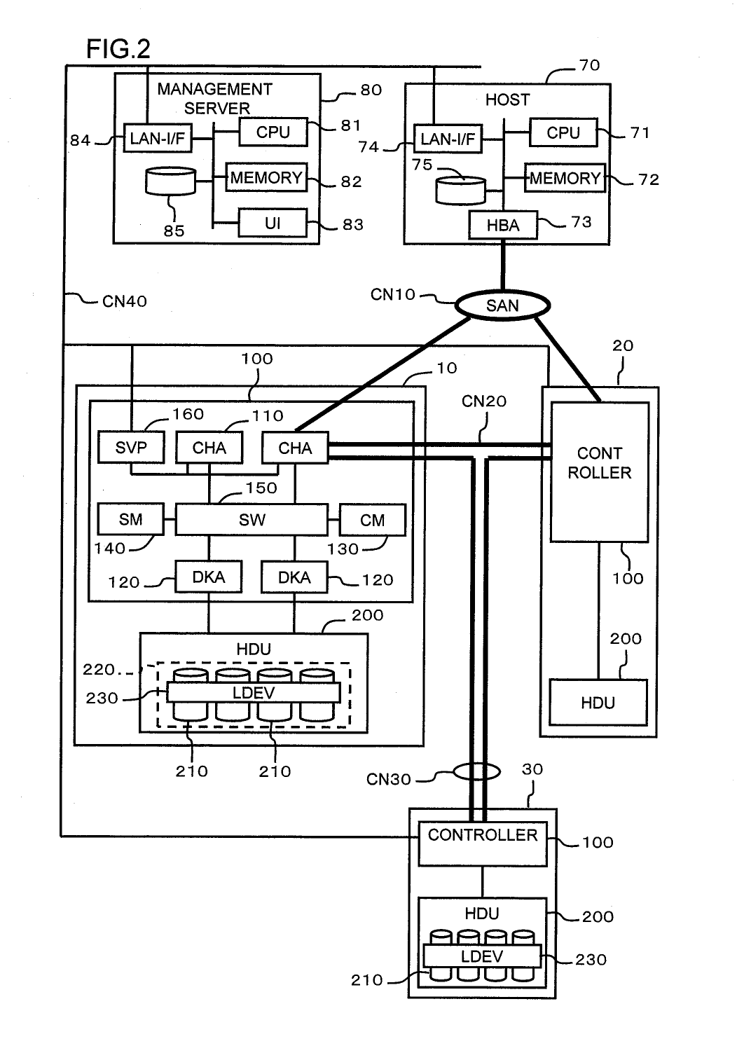

FIG. 2 is an illustration diagram showing an overall outline of a storage system in accordance with an embodiment of the present invention. At first, a correspondence relationship with FIG. 1 is described. The storage devices 10, 20, and 30 in FIG. 2 are corresponded to the storage devices 1, 2, and 3 in FIG. 1, respectively. The host 70 and the management server 80 in FIG. 2 are corresponded to the host 5 and the management server 4 in FIG. 1, respectively.

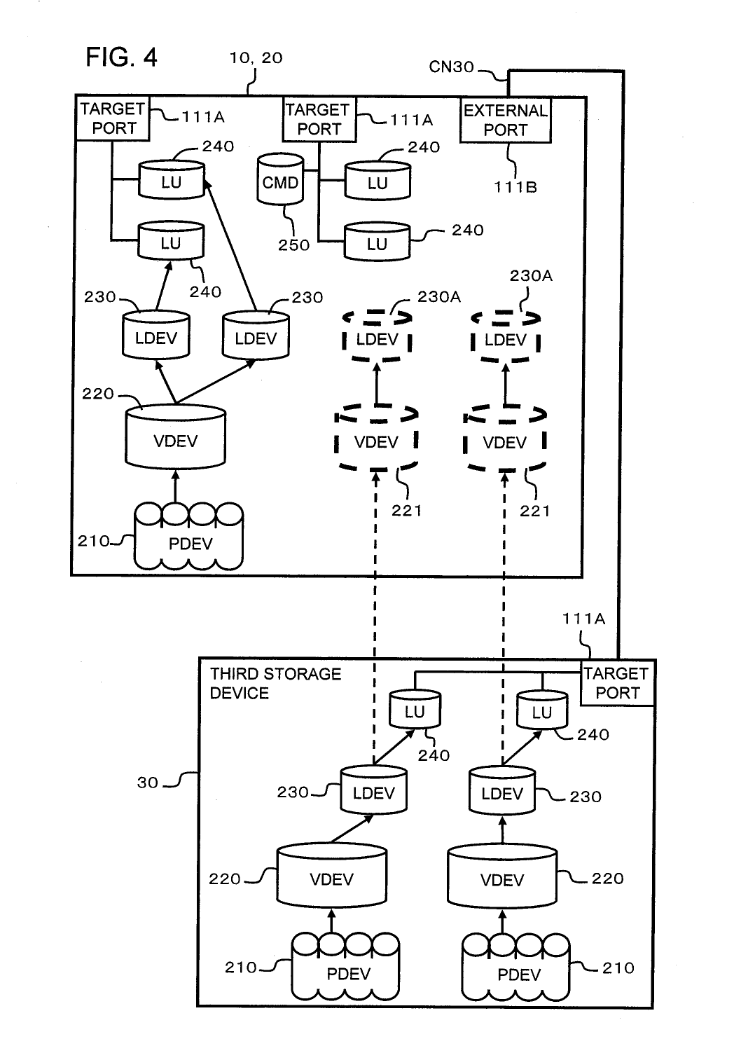

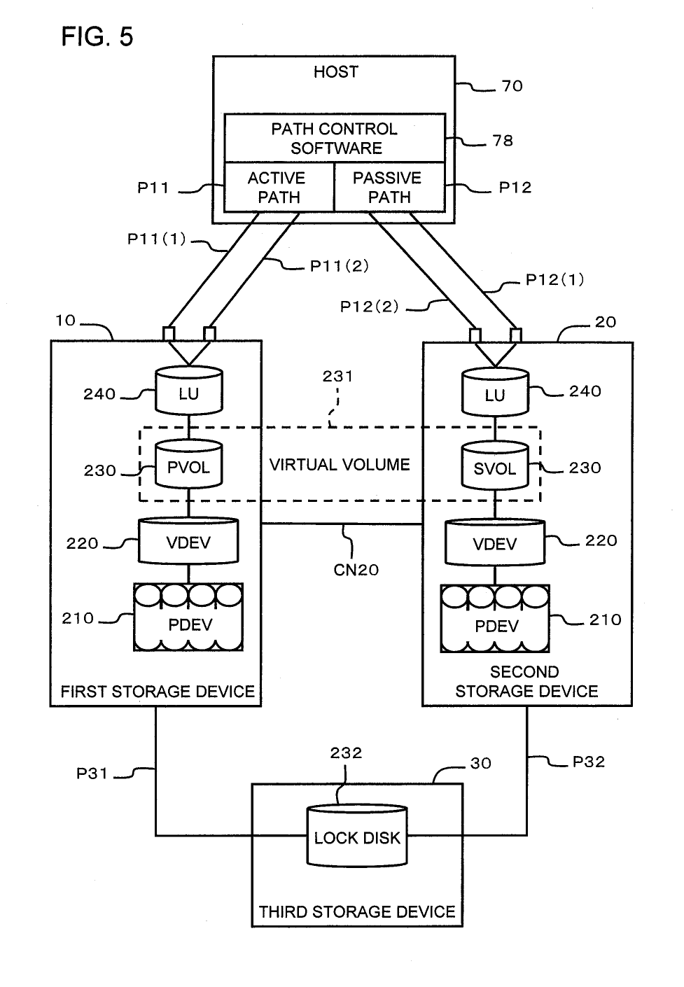

A virtual volume 231 shown in FIG. 5 is corresponded to the virtual volume 6 in FIG. 1. A lock disk 232 shown in FIG. 5 is corresponded to the lock disk 3A in FIG. 1. A logical volume 230 shown in FIG. 4 is corresponded to the logical volumes 1A and 2A in FIG. 1. A first communication network CN10 is corresponded to the first communication network CN1, a second communication network CN20 is corresponded to the second communication network CN2, a third communication network CN30 is corresponded to the third communication network CN3, and a fourth communication network CN40 is corresponded to the fourth communication network CN4. The sections that overlap to the sections described in FIG. 1 will be described briefly in the following.

The storage system is provided with a plurality of storage devices 10, 20, and 30, a host 70, and a management server 80. The storage devices 10 and 20 and the host 70 are connected to each other via a communication network CN10. The storage device 10 and the storage device 20 are connected to each other via a communication path CN20. The management server 80 is connected to the storage devices 10, 20, and 30, and the host 70 via a communication network CN40. The storage devices 10 and 20 and the storage device 30 are connected to each other via a communication path CN30.

However, the present invention is not restricted to the above configuration. For instance, the communication networks CN10 and CN30 can also be configured as one communication network. Moreover, the communication network CN40 can be eliminated, and information for a management can also be distributed by using the communication network CN10.

The configuration shown in FIG. 2 illustrates an example in which the storage devices 10 and 20 are connecting sources of the external connection and the storage device 30 is a connecting destination of the external connection. The external connection is a technique for retrieving a logical volume that exists out of the device itself into the device itself as described above. The storage devices 10 and 20 that are connecting sources of the external connection can utilize the logical volume 230 in the storage device 30. Consequently, in the case in which the storage devices 10 and 20 are provided with cache memory of a certain amount, it is not necessary for the storage devices 10 and 20 to be provided with a real volume. The storage devices 10 and 20 can be configured as a device such as a switching device or a virtualization dedicated device.

The configuration of the storage devices 10 to 30 will be described in the following. The storage devices 10 to 30 can have the same configuration. So, the storage device 10 is described as an example.

The storage device 10 is provided with a controller 100 and a storage device mounted section (hereafter referred to as HDU) 200 for instance. The controller 100 controls the operation of the storage device 10. The controller 100 is provided with a channel adapter 110 (hereafter referred to as CHA 110), a disk adapter 120 (hereafter referred to as DKA 120), a cache memory 130 (CM in the figure), a shared memory 140 (SM in the figure), a connecting control section 150 (SW in the figure), and a service processor 160 (SVP in the figure) for instance.

A first communication control section and the CHA110 that can be represented are for carrying out data communication with the host 70 or other storage devices. As shown in FIG. 4, each CHA 110 is provided with at least one communication port 111 (a reference number 111 is used as a generic term of 111A and 111B). Each CHA 110 is configured as a microcomputer system provided with a CPU and a memory and so on. Each CHA 110 interprets and executes various kinds of commands such as a read command and a write command that have been received from the host 70.

The communication function and the command interpretation and execution function can also be separated. For instance, a communication control board for communicating with the host 70 or other storage devices and an execution control board for interpreting and executing a command can also be separated.

A network address for identifying each CHA 110 (such as an IP address and a WWN (World Wide Name)) is allocated to each CHA 110. Each CHA 110 can act as a NAS (Network Attached Storage) individually. In the case in which a plurality of hosts 70 exists, each CHA 110 individually receives and processes a request from each host 70.

A second communication control section and the DKA 120 that can be represented receive and transmit data with a disk drive 210 included in the HDU 200. Similarly to the CHA 110, each DKA 120 is configured as a microcomputer system provided with a CPU and a memory and so on. Similarly to the above, the communication function and the command interpretation and execution function can also be separated.

For instance, each DKA120 writes the data that has been received by the CHA110 from the host 70 and data from other storage devices into a prescribed disk drive 210. In addition, each DKA120 reads data from the prescribed disk drive 210 and transmits the data to the host 70 or an external storage device. In the case in which each DKA120 carries out the data input/output with the disk drive 210, each DKA120 converts a logical address into a physical address.

In the case in which the disk drive 210 is managed according to RAID, each DKA120 carries out the data access corresponding to the RAID configuration. For instance, each DKA120 writes the same data into the separate disk drive group (RAID group) (RAID1), or executes a parity account to write data and a parity into the disk drive group in a distributed manner (RAID5, RAID6 or the like).

The cache memory 130 stores data that has been received from the host 70 or an external storage device. In addition, the cache memory 130 stores data that has been read from the disk drive 210. As described later, a virtual intermediate storage device (VDEV) is established by using a storage space of the cache memory 130.

The shared memory (also called a control memory in some cases) 140 stores various kinds of control information or the like that is used for operating the storage device 10. In addition, a work region is set to the shared memory 140, and the shared memory 140 stores various kinds of tables described later.

Any one or a plurality of disk drives 210 can be used as a disk for cache. Moreover, the cache memory 130 and the shared memory 140 can be configured as separate memories. It is also possible that a part of a storage region of the same memory is used as a cache region, and the other storage region of the same memory is used as a control region.

The connecting control section 150 connects each CHA 110, each DKA 120, the cache memory 130, and the shared memory 140 with each other. The connecting control section 150 can be configured as a cross path switch for instance.

The HDU200 is provided with a plurality of disk drives 210. As a disk drive 210, various kinds of storage devices such as a hard disk drive, a flash memory device, a magnetic tape drive, a semiconductor memory drive, and an optical disk drive, and an equivalent thereof can be used for instance.

For instance, the physical storage regions of the plurality of disk drives 210 can be grouped together to configure a RAID group 220. At least one logical volume 230 can be formed on the physical storage regions of the RAID group 220.

The SVP160 is connected to each CHA110 via an internal network such as LAN. The SVP160 can receive and transmit data with the shared memory 140 and the DKA120 via the CHA110. The SVP160 collects various kinds of information in the storage device 10 and provides the information to the management server 80.

The other storage devices 20 and 30 can be configured similarly to the storage device 10. However, the configurations of the storage devices 20 and 30 can be different from each other. For instance, even in the case in which the models, vendors, types, and generations of the storage devices 10 to 30 are different from each other, the present invention can be applied to the storage devices.

The configuration of the host 70 will be described. The host 70 is provided with a CPU 71, a memory 72, an HBA (Host Bus Adapter) 73, a LAN interface 74, and an internal disk 75 for instance.

The HBA 73 is a communication section for accessing the storage devices 10 and 20 via the communication network CN10, and is corresponded to a communication section 5C in FIG. 1. The LAN interface 74 is a circuit for communicating with the management server 80 via the communication network CN40 for a management.

The configuration of the management server 80 will be described. The management server 80 is a computer device for managing the configuration or the like of the storage system. For instance, the management server 80 is operated by a user such as a system administrator and a maintenance person. The management server 80 is provided with a CPU 81, a memory 82, a user interface 83 (UI in the figure), a LAN interface 84, and an internal disk 85 for instance. The LAN interface 84 communicates with the storage devices 10 to 30 and the host 70 via the communication network CN40 for a management.

The user interface 83 provides a management window described later to a user, and receives an input from a user. The user interface 83 is provided with a display device, a keyboard switch, and a pointing device for instance. The user interface 83 can have a configuration in which a variety of input can be carried out by a voice input for instance.

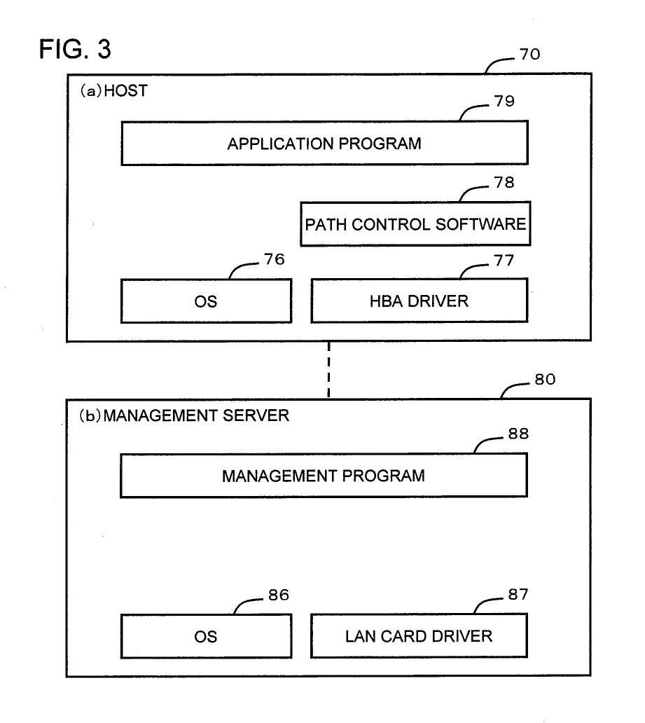

FIG. 3 is an illustration diagram schematically showing a software configuration of the host 70 and the management server 80. As shown in FIG. 3(a), the host 70 is provided with an operating system 76, an HBA driver 77, path control software 78, and an application program 79 for instance.

The HBA driver 77 is software for controlling the HBA 73. The path control software 78 is corresponded to the path control section 5B in FIG. 1. The path control software 78 decides an access path to be used for accessing corresponding to an access request from the application program 79. In the case in which there is a plurality of access paths that are connected to a volume of an access destination, the path control software 78 switches an access path set to be primary (active path) and a path set to be secondary (passive path) to be used.

In the following descriptions, the path control software 78 can be called a path control section 78 in some cases. The application program 79 is software that is corresponded to the application program 5A in FIG. 1.

As shown in FIG. 3(b), the management server 80 is provided with an operating system 86, a LAN card driver 87, and a management program 88. The management program 88 is provided with a function for directing the storage device to set the virtual volume 231, a function for directing the storage device to create the lock disk 232, and a function for setting the real volume 230 included in the storage device 30 as a virtual volume (external connection volume) in the storage devices 10 and 20. The management program 88 is corresponded to the virtual volume setting section 4A, the lock disk setting section 4B, and the external connection setting section 4C in FIG. 1.

FIG. 4 is an illustration diagram showing a storage structure of the storage system. FIG. 4 shows the configuration related to the above external connection and so on.

The storage structures of the storage devices 10 and 20 are classified broadly into a physical storage hierarchy and a logical storage hierarchy for instance. The physical storage hierarchy is configured by a PDEV (Physical Device) 210 that is a physical disk. The PDEV corresponds to the disk drive 210.

The logical storage hierarchy can be configured by a plurality of (for instance two kinds of) hierarchies. One logical hierarchy can be configured by any one of virtual VDEV 221 that is handled as the VDEV 220. The other logical hierarchy can be configured by the LDEV (Logical Device) 230.

The VDEV 220 is configured by grouping PDEV 210 of the prescribed number such as 4 pieces in 1 set (3D+1P) and 8 pieces in 1 set (7D+1P). The storage regions that are provided from each PDEV 210 included in a group are collected, and one RAID storage region is formed. The RAID storage region becomes the VDEV 220.

In contrast to the VDEV 220 that is established on a physical storage region, the VDEV 221 is a virtual intermediate storage device that does not directly require a physical storage region. The VDEV 221 is not related directly to the physical storage region, and is the basis for mapping an LU (Logical Unit) of the third storage device 30 as an external storage device. The storage device 30 of a connection destination exists outside the storage devices 10 and 20 as viewed from the storage devices 10 and 20 of a connection source. Consequently, hereafter, the storage device 30 is called an external storage device 30.

At least one LDEV 230 can be formed on the VDEV 220 or VDEV 221. The LDEV 230 is the logical volume 230 described above. The LDEV 230 is configured by dividing the VDEV 220 into parts of a prescribed size.

In the case of an open type host, the host 70 recognizes the LDEV 230 as one physical disk by mapping the LDEV 230 to the LU 240. The open type host accesses a desired LDEV 230 by specifying the LUN (Logical Unit Number) or a logical block address. The main frame type host directly recognizes the LDEV 230.

The LU 240 is a device that can be recognized as a logical unit of the SCSI. Each LU 240 is connected to the host 70 via a target port 111A. At least one LDEV 230 can be associated with each LU 240. An LU size can also be expanded virtually by associating a plurality of LDEV 230 with one LU 240.

The CMD (Command Device) 250 is a dedicated LU that is used for receiving and transmitting a command and a status between the host 70 and the storage devices 10 and 20. A command from the host 70 is written to the CMD 250. The storage devices 10 and 20 execute a processing corresponding to the command written to the CMD 250, and write the execution result to the CMD 250 as a status. The host 70 reads and confirms the status written to the CMD 250, and writes a content of a processing that is executed in the second place to the CMD 250. As described above, the host 70 can give a variety of instructions to the storage devices 10 and 20 via the CMD 250.

The storage devices 10 and 20 can directly process a command that has been received from the host 70 without storing into the CMD 250. Moreover, the CMD can be created as a virtual device and be processed by receiving a command from the host 70 without defining a substantial device (LU). For instance, the CHA 110 writes a command that has been received from the host 70 into the shared memory 140, and the CHA 110 or the DKA 120 processes the command that has been stored into the shared memory 140. The processing result is written to the shared memory 140, and is transmitted from the CHA 110 to the host 70.

The external storage device 30 is connected to an initiator port (External Port) 111B of the storage devices 10 and 20 via the communication path CN30. The communication port 111B is a communication port for an external connection.

The external storage device 30 is provided with a plurality of PDEV 210, a VDEV 220 set on a storage region provided by the PDEV 210, and at least one LDEV 230 that can be set on the PDEV 210. Each LDEV 230 is associated with an LU 240.

The LU 240 of the external storage device 30 is mapped to a VDEV 221. An LDEV230A is corresponded to the virtual VDEV 221. The storage devices 10 and 20 use a logical volume (a lock disk) in the external storage device 30 via the LDEV230A.

FIG. 5 is an illustration diagram schematically showing a configuration of the storage system. As shown in FIG. 5, the host 70 and the storage device 10 are connected to each other via a plurality of communication paths P11(1) and P11(2). The host 70 and the storage device 20 are also connected to each other via a plurality of communication paths P12(1) and P12(2). In a normal case, the communication paths P11(1) and P11(2) are active paths, and the communication paths P12(1) and P12(2) are passive paths. In the case in which any of the plurality of active paths P11(1) and P11(2) cannot be used, a path control section 78 switches to the passive paths P12(1) and P12(2). The path control section 78 switches and uses two active paths P11(1) and P11(2) based on the round robin fashion. Similarly, the path control section 78 switches and uses two passive paths P12(1) and P12(2).

One virtual volume 23 is formed by a logical volume 230 (a primary volume) in the storage device 10 and a logical volume 230 (a secondary volume) in the storage device 20. The primary volume and the secondary volume form a remote copy pair.

In a normal case, the host 70 accesses a primary volume in the storage device 10. In the case in which the host 70 updates data that has been stored into the primary volume, the updated data is transmitted from the storage device 10 to the storage device 20, and is reflected to a secondary volume in the storage device 20. The same identifier is set to each logical volume 230 that configures the virtual volume 231. Consequently, the path control section 78 cannot distinguish each logical volume 230, and recognizes each logical volume 230 as the same device.

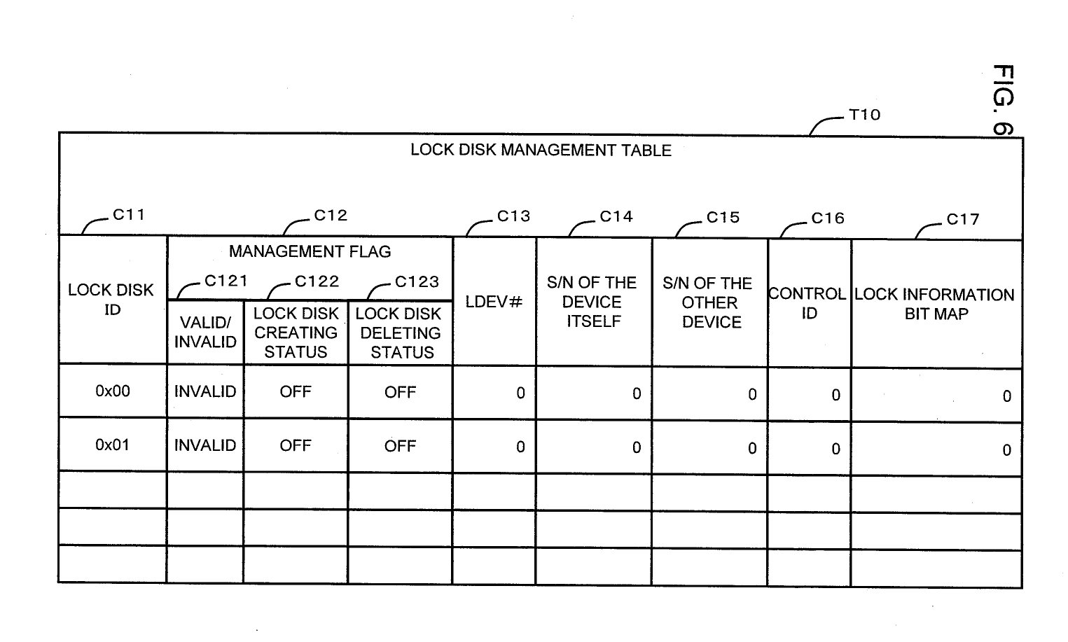

FIG. 6 shows a table T10 for managing a lock disk. The lock disk management table T10 has been stored into the shared memory 140 in each of the storage devices 10 and 20.

For instance, the lock disk management table T10 is provided with a lock disk identifier C11 (hereafter an identifier is referred to as ID in some cases), a management flag C12, an LDEV number C13 of the lock disk, a production number C14 of the device itself, a production number C15 of the other device, a control identifier C16, and a lock disk information bit map C17.

The lock disk ID C11 is the information for uniquely identifying the lock disk 232 in the storage system. The management flag C12 is the information for managing a status of the lock disk 232 and so on. The management flag C12 includes a valid/invalid flag C121, a lock disk creating status flag C122, and a lock disk deleting status flag C123 for instance.

The valid/invalid flag C121 is a flag for indicating that the lock disk 232 is valid or invalid. The lock disk creating status flag C122 is a flag for indicating that the lock disk 232 is being created. In the period from that the storage device is instructed to create the lock disk 232 to that a creation completion of the lock disk is reported, a status of the lock disk is set to “in process of creation”.

The lock disk deleting status flag C123 is a flag for indicating that the lock disk 232 is being deleted. In the period from that the storage device is instructed to delete the lock disk 232 to that a deletion completion of the lock disk is reported, a status of the lock disk is set to “in process of deletion”.

The LDEV number C13 indicates a number of the logical volume 230 that is used as the lock disk 232. The logical volume 230 in the third storage device 30 is sued as the lock disk 232.

A production number of the storage device 10 is set to the production number C14 of the device itself in the case in which the lock disk management table T10 has been stored into the storage device 10. On the other hand, a production number of the storage device 20 is set to the lock disk management table T10 in the storage device 20 as the production number C14 of the device itself.

A production number of the storage device 20 is set to the production number C15 of the other device in the case in which the lock disk management table T10 has been stored into the storage device 10. On the other hand, a production number of the storage device 10 is set to the production number C15 of the other device in the case of the lock disk management table T10 in the storage device 20.

A number that indicates a generation of the storage device is set to the control ID C16. Even in the case in which storage devices of different generations exist together in the storage system, the information of a generation of the storage device is also managed for identifying each storage device correctly. By combining a control ID and a production number, each storage device can be uniquely specified.

The lock information of the virtual volume 231 corresponded to the lock disk 232 (in other words, the lock information related to a remote copy pair that configures the virtual volume 231) is set to the lock disk information bit map C17 in a bit map system.

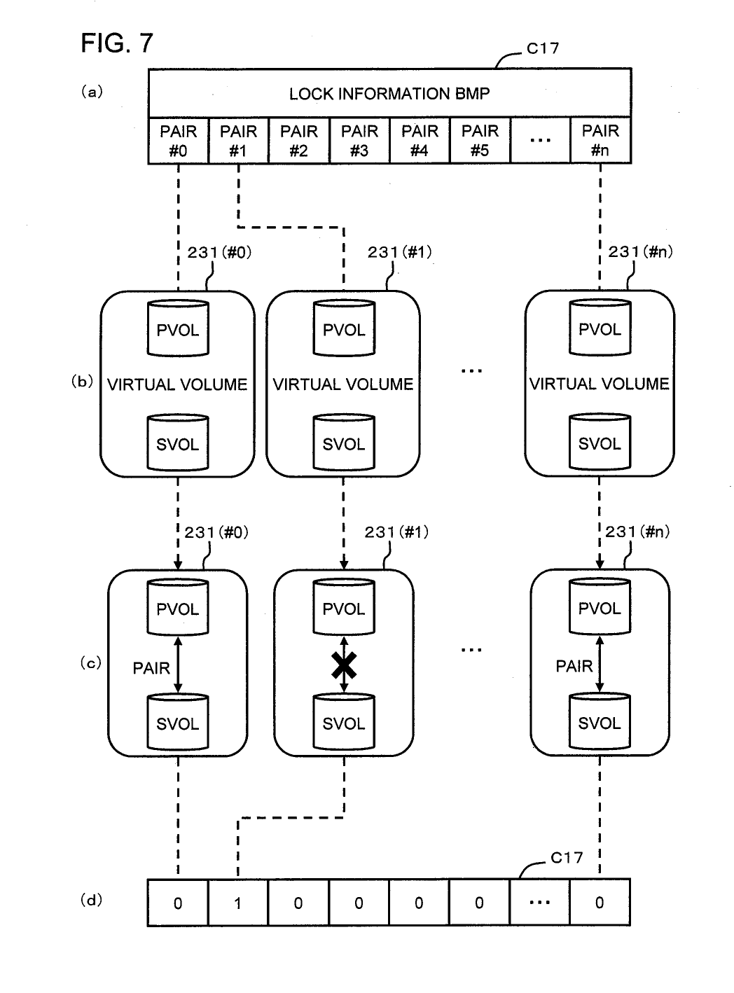

FIG. 7 is an illustration diagram schematically showing a configuration of a lock disk information bit map C17. In the lock disk information bit map C17, one bit is allocated to one or a plurality of virtual volumes (shown as “pair” in FIG. 7) (FIG. 7(b)) that are managed by the lock disk 232 (FIG. 7(a)).

As shown in FIGS. 7(c) and 7(b), in the case in which each volume (a primary volume and a secondary volume) that configures a remote copy pair related to the virtual volume 231 is in a pair status, “0” is set to the bit corresponding to the pair.

On the other hand, a failure or the like causes a pair to be canceled, any one of the primary volume and the secondary volume is updated by the host 70, and the storage content of the primary volume and the storage content of the secondary volume are not equivalent to each other. Consequently, in the case in which a remote copy pair is canceled, “1” is set to the bit corresponding to the virtual volume.

In the case in which the operation of the virtual volume 231 is continued by using the primary volume, “1” is set to the bit corresponding to the lock disk information bit map C17 in the lock disk management table T10 in the storage device 10. In the lock disk management table T10 in the storage device 20, a value of the corresponding bit in the lock disk information bit map C17 is “0”.

On the other hand, in the case in which the operation of the virtual volume 231 is continued by using the secondary volume, “1” is set to the bit corresponding to the lock disk information bit map C17 in the lock disk management table T10 in the storage device 20. In the lock disk management table T10 in the storage device 10, a value of the corresponding bit in the lock disk information bit map C17 is “1”.

In other words, the lock disk information bit map C17 indicates which volume is used for operating the virtual volume 231 among a plurality of volumes that configure the virtual volume 231. In other words, the lock disk information bit map C17 indicates which storage device is in charge of the operation of the virtual volume 231 among a plurality of storage devices 10 and 20.

FIG. 8 is an illustration diagram showing a configuration example of the usage control information L10 that is stored into the lock disk 232. For instance, the usage control information L10 is provided with the management information L11, the control information L12 of the first storage device 10, the control information L13 of the second storage device 20, the lock information bit map L14 of the first storage device 10, and the lock information bit map L15 of the second storage device 20.

For instance, the management information L11 includes the lock disk ID L111, a production number L112 of the first storage device 10, and a production number L113 of the second storage device 20. As described above, the lock disk ID L111 is the identification information for uniquely specifying the lock disk 232 in the storage system.

The control information L12 of the first storage device 10 is the information for indicating whether the first storage device 10 is using the lock disk 232 or not. “1” is set in the case in which the first storage device 10 is using the lock disk 232, and “0” is set in the case in which the first storage device 10 is not using the lock disk 232. Similarly, the control information L13 of the second storage device 20 is the information for indicating whether the second storage device 20 is using the lock disk 232 or not.

As described above, the lock information bit map L14 of the first storage device 10 and the lock information bit map L15 of the second storage device 20 are the information for indicating which storage device uses the virtual volume 231 that is managed by the lock disk 232, that is, which logical volume of the main and secondary volumes stores the difference data.

Here, the first storage device 10 can write a value to a production number L112 of the first storage device 10, the control information L12 of the first storage device 10, and the lock information bit map L14 of the first storage device 10 by accessing the lock disk 232. The first storage device 10 cannot rewrite a production number L113 of the second storage device 20, the control information L13 of the second storage device 20, and the lock information bit map L15 of the second storage device 20.

Similarly, the second storage device 20 can update only items L113, L13, and L15 related to the device itself. The lock disk ID L111 is written by the storage device that has created the lock disk 232.

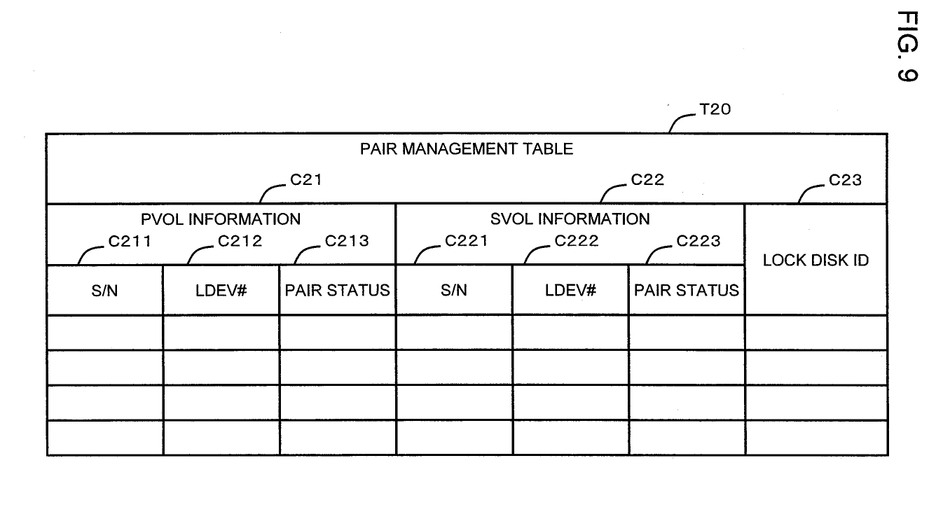

FIG. 9 is an illustration diagram showing a pair management table T20. The pair management table T20 manages a remote copy pair that configures the virtual volume 231. For instance, the pair management table T20 is provided with an item C21 related to the primary volume (PVOL in the figure), an item C22 related to the secondary volume (SVOL in the figure), and a lock disk ID C23.

For instance, the item C21 related to the primary volume includes a production number C211 of the storage device in which the primary volume exists, an LDEV number C212 of a logical volume that is used as the primary volume, and a pair status C213.

Similarly, for instance, the item C22 related to the secondary volume includes a production number C221 of the storage device in which the secondary volume exists, an LDEV number C222 of a logical volume that is used as the secondary volume, and a pair status C223.

As a pair status, there can be mentioned for instance a pair, an SMPL (simplex), a PSUS (suspend: single operation of PVOL), an SSWS (swap suspend: single operation of SVOL), a pair re-synch, and a reverse re-synch.

The pair is a status in which the primary volume and the secondary volume form a remote copy pair and in which the storage content of the primary volume and the storage content of the secondary volume are equivalent to each other. The SMPL is a status that indicates the volume is a normal logical volume. The PSUS indicates a status in which the primary volume is in a suspend status and the primary volume independently operates the virtual volume 231. The SSWS indicates a status in which the secondary volume is switched to and the secondary volume independently operates the virtual volume 231. The pair re-synch indicates a status in which the storage content of the primary volume and the storage content of the secondary volume are re-synchronized with each other. The reverse re-synch indicates a status in which a difference that has been stored into the secondary volume is written to the primary volume and the primary volume and the secondary volume are synchronized with each other.

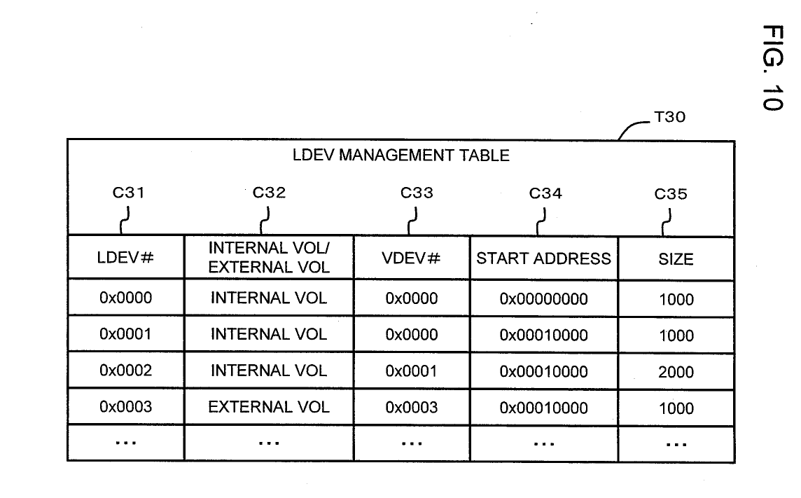

FIG. 10 is an illustration diagram showing a table T30 for managing a logical volume by each storage device. An LDEV management table T30 has been stored into the shared memory 140 of the storage devices 10 and 20.

For instance, the LDEV management table T30 includes an LDEV number C31, a volume type C32; a VDEV number C33, a start address C34, and a size C35. The LDEV number C31 is the identification information for managing the logical volume 230 in each of the storage system.

The volume type C32 indicates the distinction between that a volume is configured as an internal volume and that a volume is configured by using an external volume. A volume that is configured as an internal volume is a real volume that uses the physical storage region in the storage device. A volume that is configured by using an external volume is a volume (an external connection volume) that uses a volume (an external volume) in the external storage device 30.

The VDEV number C33 is the information for specifying a VDEV that includes the volume. The start address C34 indicates a portion of the physical storage region of the VDEV from which the volume is started. The size C35 is a storage capacity of the volume.

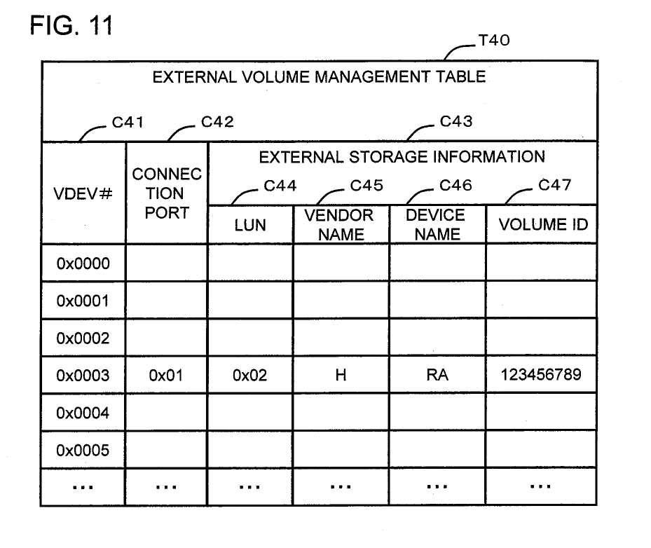

FIG. 11 is an illustration diagram showing a table T40 for managing an external volume. The external volume management table T40 has been stored into the shared memory 140 in each of the storage devices 10 and 20.

For instance, the external volume management table T40 includes a VDEV number C41, a connection port C42, and the external storage information C43. The VDEV number C41 is the information for specifying a VDEV. The connection port C42 is the information for specifying a communication port 111B to which the external storage device is connected.

The external storage information C43 indicates the configuration of the external storage device 30. The external storage information C43 includes a LUN C44, a vendor name C45, a device name C46, and a volume identifier C47. The LUN C44 indicates a LUN that is corresponded to an external volume. The vendor name C45 indicates a name of a provider of the external storage device. The device name C46 indicates a number (a production number) for specifying the external storage device. The volume identifier C47 is an identifier for identifying an external volume in the external storage device 30 by the external storage device 30.

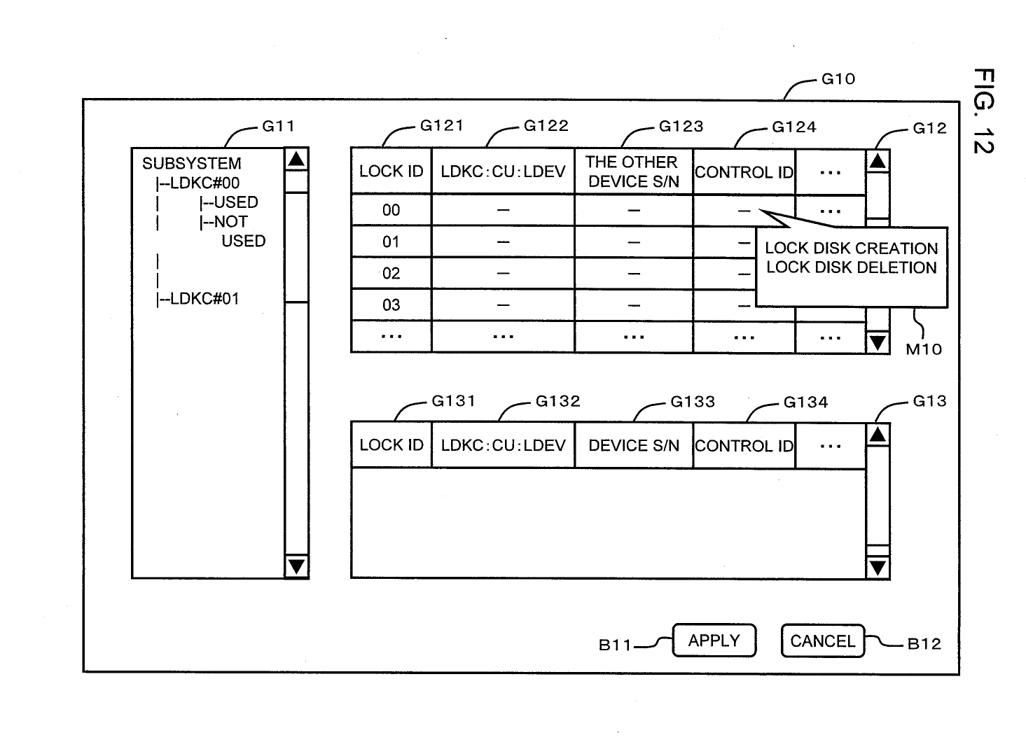

FIG. 12 is an illustration diagram showing a lock disk management window G10. The management server 80 can access the SVP 160 to display the setting window shown in FIG. 12 on the display device of the management server 80.

For instance, the lock disk management window G10 includes a tree display section G11 that shows a tree configuration of the storage system, the LDEV information display section G12 that shows the information related to the LDEV, and the preview display section G13.

The tree display section G11 shows the configuration of the storage system in a unit of a storage device (a DKC unit), in a unit of a virtual storage device that is formed virtually in a storage device (a LDKC unit), in a unit of a lock disk being used, and in a unit of a lock disk that is not used for instance.

For instance, the LDEV information display section G12 is provided with a lock disk ID display section G121 that shows a lock disk ID, an LDEV specifying section G122 that shows the LDEV specific information for specifying the LDEV (the logical volume 230) that is used as a lock disk, a production number display section G123 that shows a production number of a device provided with the other volume (in other words, the other device) for configuring the virtual volume 231, and a control ID display section G124 that shows a control ID for indicating a generation of the other storage device.

In the LDEV information display section G12, in the case in which a mouse pointer is pointed to a desired line and the right mouse button is clicked, a so-called context menu M10 appears. The context menu M10 includes the items of a lock disk creation and a lock disk deletion for instance. A user can create or delete a lock disk 232 by using the context menu M10.

In the preview display section G13, a value that has been set in the LDEV information display section G12 by a user is shown. In the case in which a user wants to use the set value, the user operates the “Apply” button B11. By this operation, a lock disk creating processing or a lock disk deleting processing that is described later is carried out.

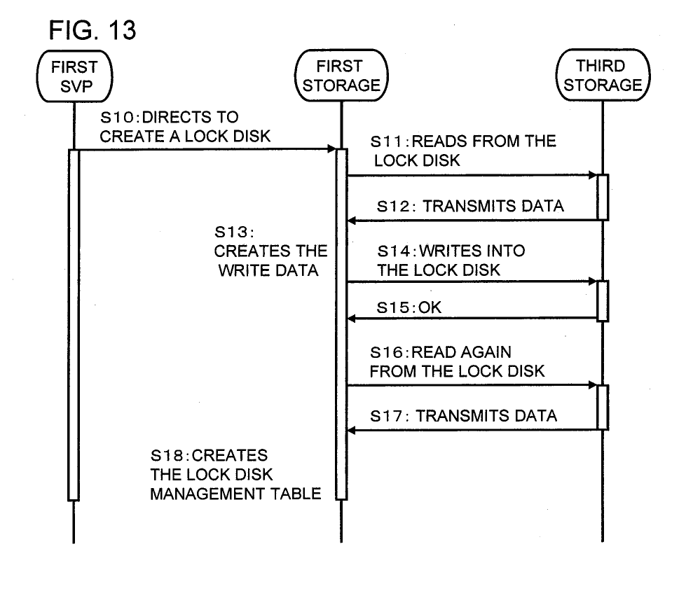

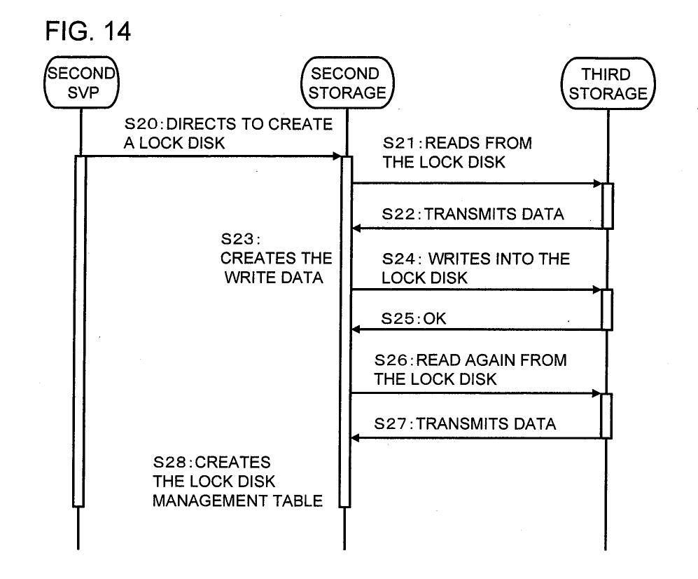

FIGS. 13 and 14 are flowcharts showing a processing for creating a lock disk. The flowchart that will be described in the following shows the outline of each processing at a level in which a person having ordinary skill in the art can understand and carry out the processing, and may be different from an actual computer program in some cases. So-called a person having ordinary skill in the art can change or delete the steps shown in the figure and can add a new step. In the following descriptions, the SVP 160 in the first storage device 10 is called a first SVP, and the SVP 160 in the second storage device 20 is called a second SVP.

FIG. 13 is a flowchart showing a processing for creating a lock disk that is carried out by the first storage device 10. FIG. 14 is a flowchart showing a processing for creating a lock disk that is carried out by the second storage device 20. The both of the processing for creating a lock disk are equal to each other. Consequently, a processing for creating a lock disk that is carried out by the first storage device 10 will described mainly.

A user accesses the first SVP via the management server 80, and directs the first storage device 10 to create a lock disk by using the lock disk management window G10 described in FIG. 12 (S10).

The lock disk creating direction includes a lock disk ID (G121), the LDEV specific information (G122), a production number of the other storage device (G123), and a control ID (G124).

The first storage device 10 refers to the lock disk management table T10 that has been stored into the shared memory 140 in the first storage device 10, and confirms that a lock disk ID that has been specified by the first SVP is not being used.

The first storage device 10 then issues a read command to the third storage device 30, and reads the usage control information L10 that has been stored into the lock disk 232 (S11). The third storage device 30 transmits the requested usage control information L10 to the first storage device 10 (S12).

The first storage device 10 confirms that a lock disk ID that has been specified in S10 is not being used by other storage devices (not shown) based on the usage control information L10. In the case in which the lock disk ID that has been specified in S10 is not being used, or in the case in which the lock disk ID is being used and the specified lock disk ID, a production number of the device itself, and a production number of the other device are equivalent to each other, the first storage device 10 creates a write data for updating the usage control information L10 (S13).

The write data is created as described in the following for instance. In the case in which the lock disk ID that has been specified by the first SVP is not being used, the first storage device 10 uses the specified lock disk ID as a lock disk ID L111.

In the case in which the specified lock disk ID is being used, and the specified lock disk ID, a production number L112 of the first storage device 10 corresponding to the lock disk ID, and a production number L113 of the second storage device 20 are equivalent to a value of the management information L11, the first storage device 10 uses the lock disk ID L111 in the management information L11 without modification.

Moreover, the first storage device 10 sets a flag (=1) that indicates that the lock disk ID is being used to the control information L12 of the first storage device 10. Furthermore, the first storage device 10 zeros out the lock information bit map L14 of the first storage device 10.

The first storage device 10 writes the write data that has been created as described above into a lock disk 232 (S14). The third storage device 30 notifies the first storage device 10 that the writing has been completed (S15).

Here, when the write data is written into the lock disk 232, other storage device not shown may issue anther write command to the third storage device 30 to rewrite the content of the lock disk 232 in some cases. Consequently, in the embodiment in accordance with the present invention, the first storage device 10 issues a read command to the third storage device 30 to read again the usage control information L10 that has been stored into the lock disk 232 (S16). The third storage device 30 transmits the usage control information L10 to the first storage device 10 corresponding to the read command (S17).

The first storage device 10 confirms that the write processing (the update processing) of S14 has been normally completed based on the usage control information L10 that has been obtained from the lock disk 232. If the usage control information L10 that has been obtained again in S16 and S17 and the usage control information L10 that has been updated again in S14 and S15 are not equivalent to each other, the first storage device 10 carries out again the processing of S14 and subsequent processing.

In the case in which the usage control information L10 is updated correctly, the first storage device 10 creates (updates) the lock disk management table T10 has been stored into the shared memory 140 based on the usage control information L10 (S18).

The first storage device 10 updates the values of a management flag C12, an LDEV number C13, a production number C14 of the device itself, a production number C15 of the other device, a control ID C16, and a lock disk information bit map C17 in the lock disk management table T10 (S18).

The management server 80 makes inquiries periodically to the first storage device 10 via the first SVP whether a creation of a lock disk has been completed or not. In the case in which the management server 80 confirms that a creation of a lock disk has been completed, the management server 80 notifies a user that a creation of a lock disk has been completed by a display on the computer window.

FIG. 14 is a flowchart showing a processing for creating a lock disk that is carried out by the second storage device 20. The processing is provided with the steps equivalent to those in the processing described in FIG. 13. S20 to S28 in FIG. 14 are corresponded to S10 to S18 in FIG. 13. Consequently, overlapped descriptions are omitted.

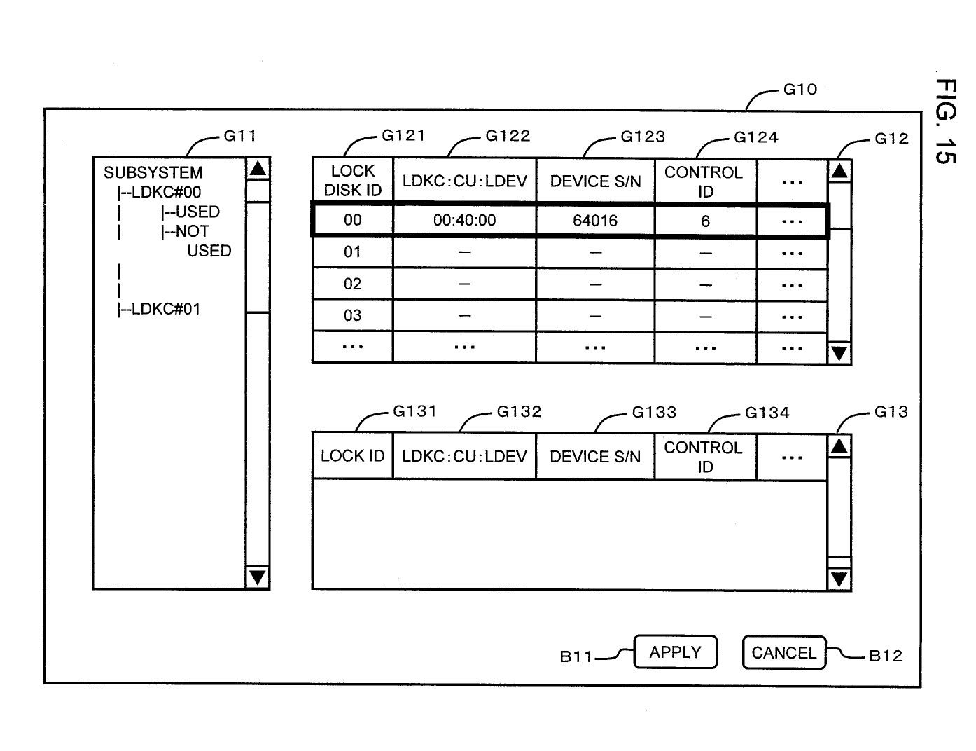

FIG. 15 is an illustration diagram showing a lock disk management window G10 in the case in which a lock disk is created. For instance, a user selects “00” as a lock disk ID (G121), a logical volume specified by “00:40:00” as the lock disk 232, “64016” as a production number of the other device related to the virtual volume 231, and “6” as a control ID.

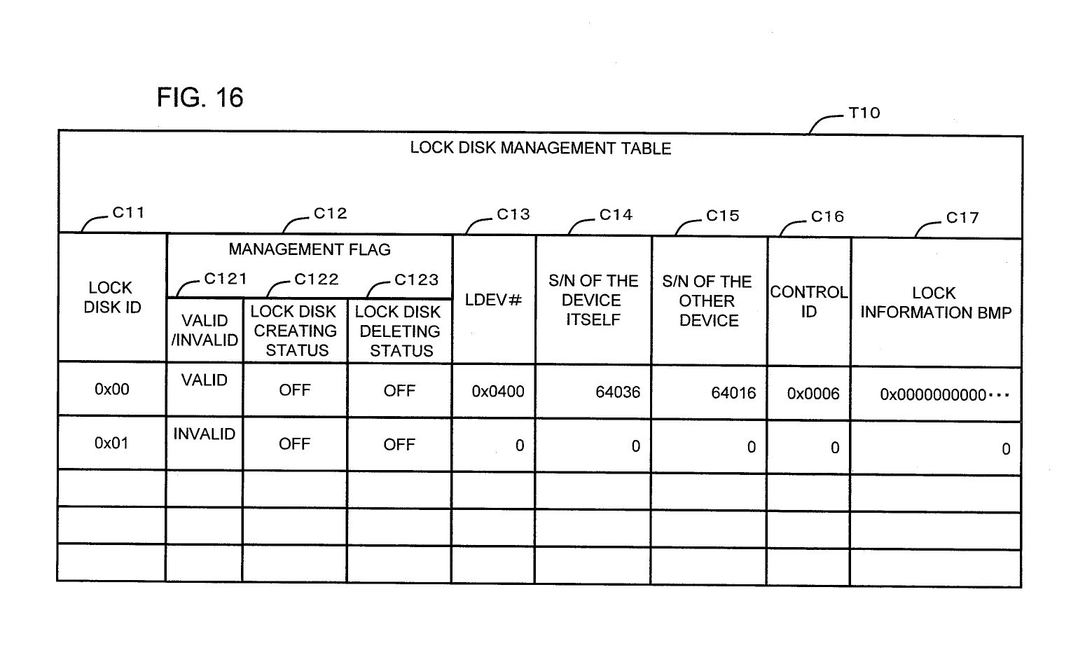

FIG. 16 is an illustration diagram showing a lock disk management table T10 after a lock disk is created. For instance, “0x00” (=00) is set to the lock disk ID C11, “valid” is set to the valid/invalid flag C12, “0x0040” (=00:40:00) is set to the LDEV number C13, “64036” is set to the production number C14 of the device itself, “64016” is set to the production number C15 of the other device, and“0x0006” (=6) is set to the control ID C16. A column of “0” is set to the lock disk information bit map C17.

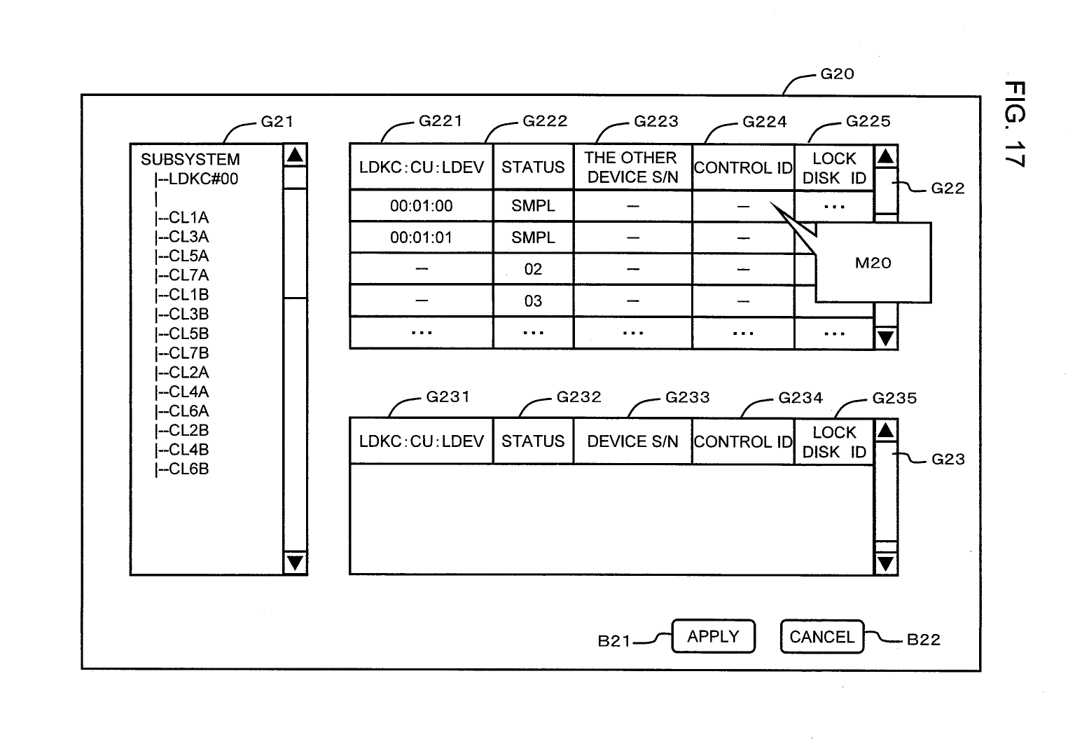

FIG. 17 is an illustration diagram showing a window G20 for managing a remote copy. The remote copy management window is provided with a tree display section G21, an LDEV information display section G22, and a preview display section G23.

For instance, the tree display section G21 shows the LDEV information for the whole storage device, for every virtual storage device in the storage device, or for every port.

For instance, the LDEV information display section G22 is provided with an LDEV specifying section G221 for specifying an LDEV (a logical volume), a status G222 of the LDEV, a production number C223 of the other device, a control ID G224, and a lock disk ID G225.

For instance, the preview display section G23 is provided with an LDEV specifying section G231, a status G232, a production number C233 of the other device, a control ID G234, and a lock disk ID G225.

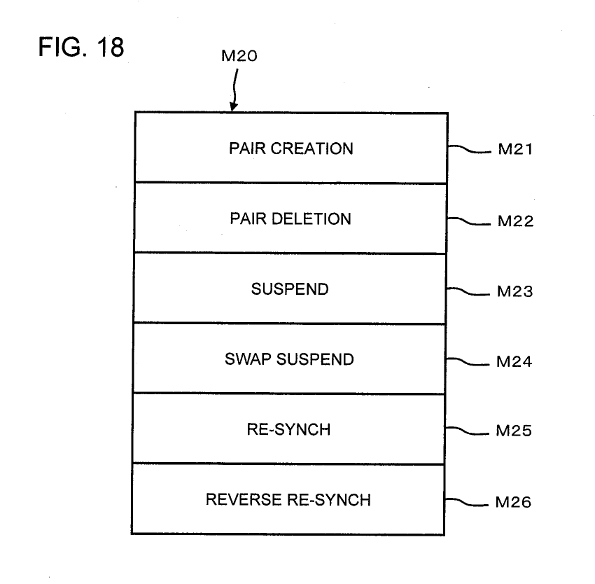

For instance, in the case in which a use clocks the right mouse button at the LDEV information display section G22, a context menu M20 is displayed. FIG. 18 is an illustration diagram schematically showing the configuration example of the context menu M20.

For instance, the context menu M20 is provided with a plurality of sub menus such as a pair creation M21, a pair deletion M22, a suspend M23, a swap suspend M24, a re-synch M25, and a reverse re-synch M26.

The pair creation M21 is a sub menu for creating a remote copy pair that configures the virtual volume 231. The pair deletion M22 is a sub menu for deleting a remote copy pair that configures the virtual volume 231. The suspend M23 is a sub menu for making a remote copy pair be in a suspend status. The swap suspend M24 is a sub menu for making a remote copy pair be in a suspend status and for continuing an operation of the virtual volume 231 by using the secondary volume. In other words, the swap suspend indicates a fail-over from the primary volume to the secondary volume. The re-synch M25 is a sub menu for transmitting a difference generated in the primary volume and for synchronizing the contents of the both volumes with each other. The reverse re-synch M26 is a sub menu for transmitting a difference generated in the secondary volume and for synchronizing the contents of the both volumes with each other.

A user can create a remote copy pair that configures the virtual volume 231 by selecting two logical volumes in a simplex status and by specifying the pair creation M21. Moreover, a user can delete a remote copy pair by selecting any one of the primary volume and the secondary volume that configure the remote copy pair and by specifying the pair deletion M22.

In the case in which a user approves the content that is displayed on the preview display section G23, the user operates the “Apply” button B21. On the other hand, in the case in which a user cancels the content that is displayed on the preview display section G23, the user operates the “Cancel” button.

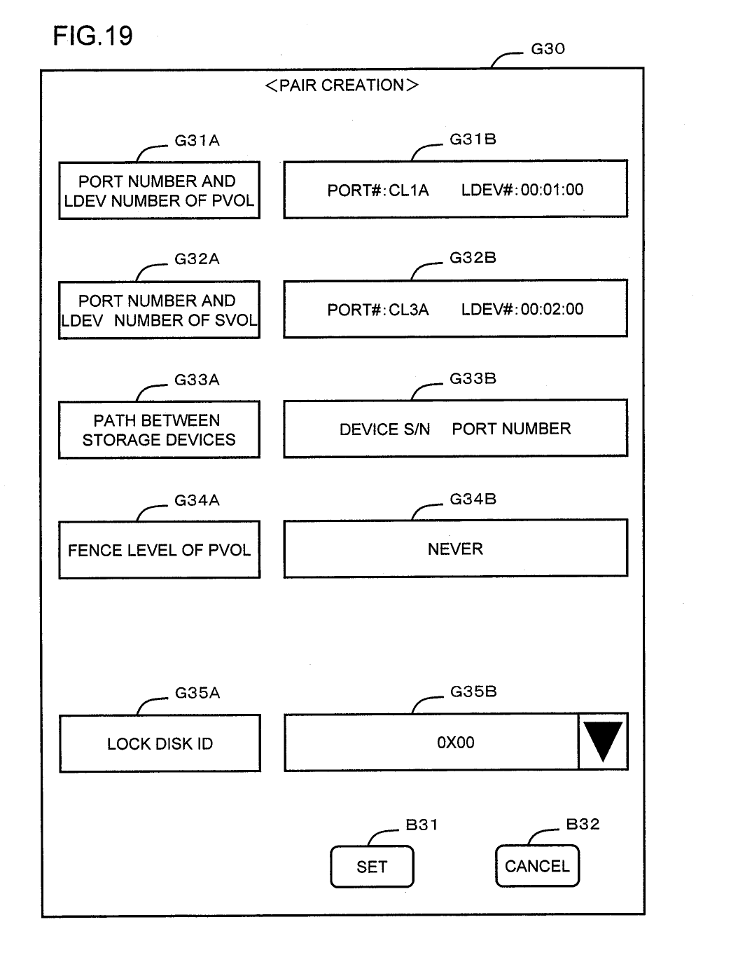

FIG. 19 is an illustration diagram showing a pair creation window G30 that is displayed on the computer screen of the management server 80 in the case in which the pair creation M21 is operated. For instance, the pair creation window G30 is provided with the primary volume setting sections G31A and G31B, the secondary volume setting sections G32A and G32B, the path setting sections G33A and G33B between storage devices, the fence level setting sections G34A and G34B of the primary volume, and the lock disk ID setting sections G35A and G35B.

In the primary volume setting sections G31A and G31B, the information for specifying a logical volume that is used as the primary volume and the information for specifying a communication port that is connected to the logical volume are set.

In the secondary volume setting sections G32A and G32B, the information for specifying a logical volume that is used as the secondary volume and the information for specifying a communication port that is connected to the logical volume are set.

In the path setting sections G33A and G33B between storage devices, a communication path CN20 for carrying out a remote copy between a storage device provided with the primary volume and a storage device provided with the secondary volume is set.

In the fence level setting sections G34A and G34B of the primary volume, a fence level is set. As a value of the fence level, there are “Data” and “Never”. In the case in which “Data” is set to a value of the fence level, it is ensured that the storage content of the primary volume and the storage content of the secondary volume are synchronized with each other when a failure occurs. In other words, when a failure occurs, a data update for the virtual volume 231 is stopped. On the other hand, in the case in which “Never” is set to a value of the fence level, a data update for the virtual volume 231 is carried out by using any one of the primary volume and the secondary volume even when a failure occurs. In the case in which “Data” is set to a value of the fence level for the remote copy pair that configures the virtual volume 231, the characteristic of the virtual volume 231, that is, an operation continuation at an occurrence of a failure is lost. Consequently, in the embodiment in accordance with the present invention, “Never” is set to an initial value of the fence level.

In the lock disk ID setting sections G35A and G35B, an ID of the lock disk 232 for managing a usage of the virtual volume 231 is set. In the case in which each set value is approved, a user operates the “Set” button B31. On the other hand, in the case in which a user cancels each set value, a user operates the “Cancel” button B32.

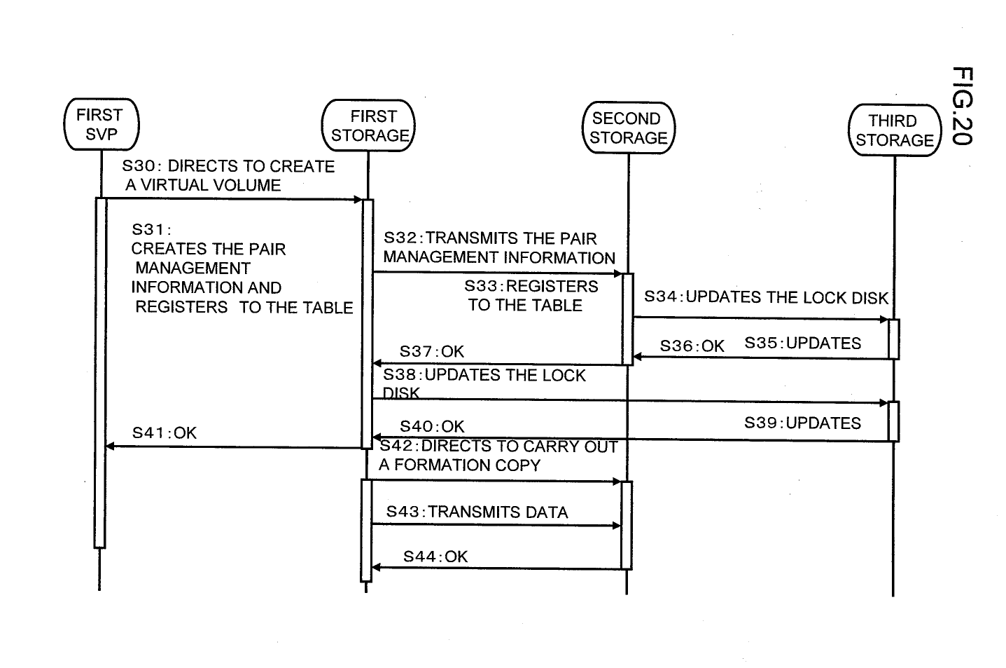

FIG. 20 is a flowchart showing a processing for setting a remote copy pair. The management server 80 directs the first storage device 10 to create the virtual volume 231 based on the remote copy pair via the first SVP (S30).

The creating direction includes each of values (G31B to G35B) included in G30. The first storage device 10 creates the pair management table T20 based on the values (G31).

The first storage device 10 transmits the content of the pair management table T20 to the second storage device 20 via the inter-device communication path CN20 (S32). The second storage device 20 registers the information that has been received from the first storage device 10 to the pair management table T20 in the second storage device 20 (S33).

The second storage device 20 refers to the lock disk management table T10 and updates the lock disk 232 in the third storage device 30 (S34). The third storage device 30 updates the usage control information L10 that has stored into the lock disk 232 based on a request from the second storage device 20 (S35), and informs the second storage device 20 that the update has been completed (S36).

In the update processing, as described above, the second storage device 20 reads the usage control information L10 immediately after the update from the lock disk 232 and inspects the information to confirm whether the update has been completed normally or not. In the case in which the update of the usage control information L10 is completed, the second storage device 20 informs the first storage device 10 that the update of the lock disk 232 has been completed (S37).

Here, the second storage device 20 can update only items L113, L13, and L15 related to the second storage device 20 in the usage control information L10, and cannot update items L112, L12, and L14 related to the first storage device 10 (the lock disk ID L111 can be set by the second storage device 20).

Next, the first storage device 10 sets items that have not been set in the usage control information L10 (S38). The third storage device 30 updates the usage control information L10 that has stored into the lock disk 232 based on a request from the first storage device 10 (S39), and informs the first storage device 10 that the update has been completed (S40).

In the case in which the first storage device 10 confirms that the usage control information L10 has been created, the first storage device 10 informs the management server 80 via the first SVP that the virtual volume 231 based on the remote copy pair has been created (S41).

After that, an initial copy (a formation copy) of the remote copy pair is carried out at a separate timing (S42 to S44). The first storage device 10 notifies the second storage device 20 of the start of the formation copy (S42), and transmits the storage content of the primary volume to the secondary volume (S43). The second storage device 20 writes the storage content of the primary volume into the secondary volume, and notifies the first storage device 10 of the write completion (S44). In the case in which the formation copy is completed, the storage content of the primary volume and the storage content of the secondary volume are synchronized with each other.

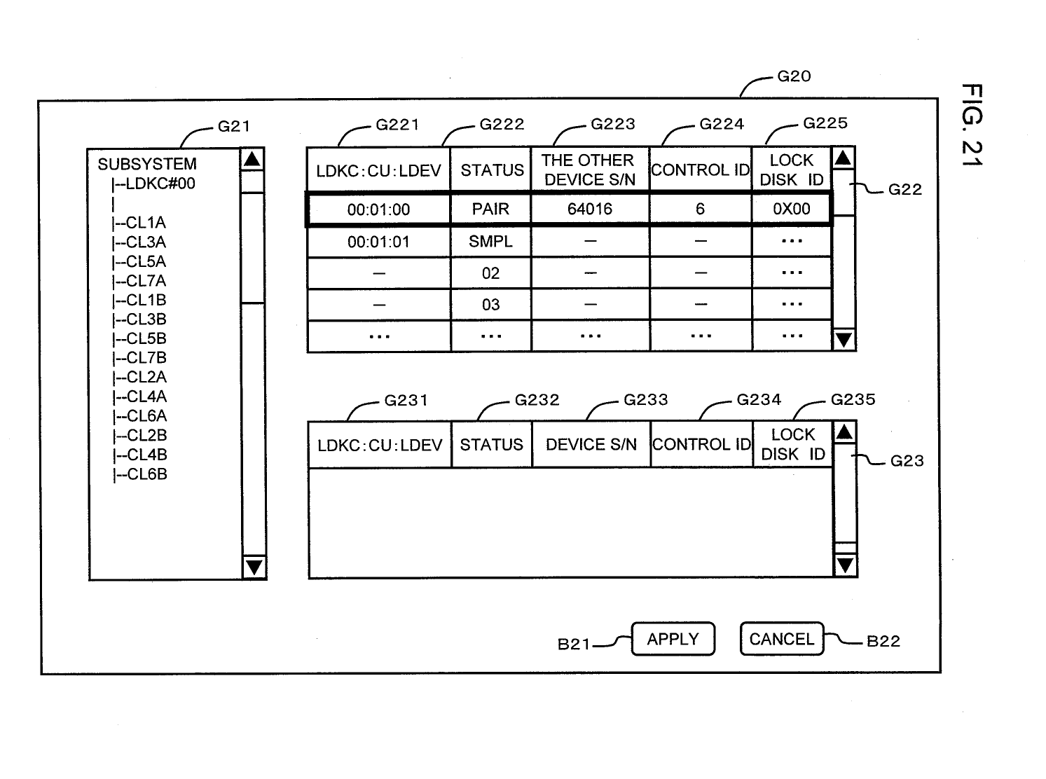

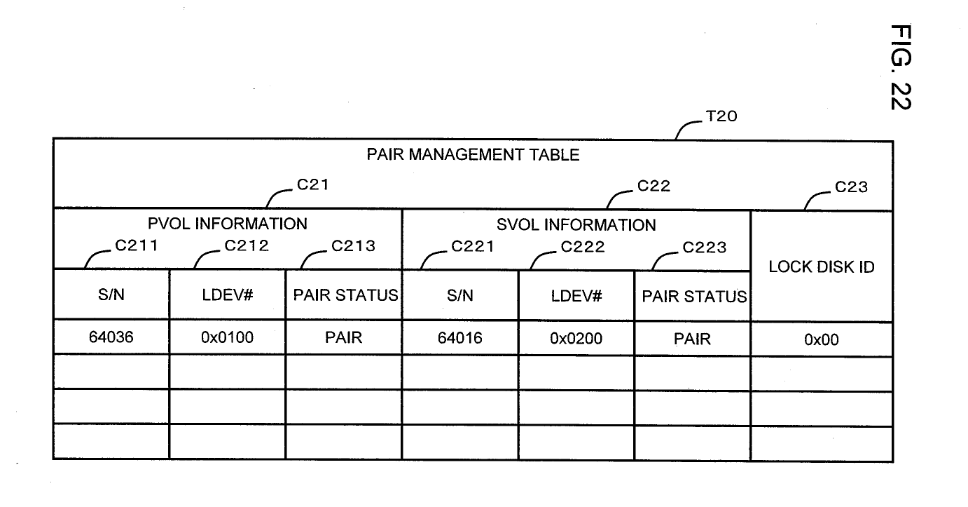

FIG. 21 is an illustration diagram showing a remote copy management window G20 after a remote copy pair that configures the virtual volume 231 is created. FIG. 22 is an illustration diagram showing a pair management table T20 after a remote copy pair that configures the virtual volume 231 is created. A status of the volume related to a remote copy pair is changed from “simplex” to “pair”.

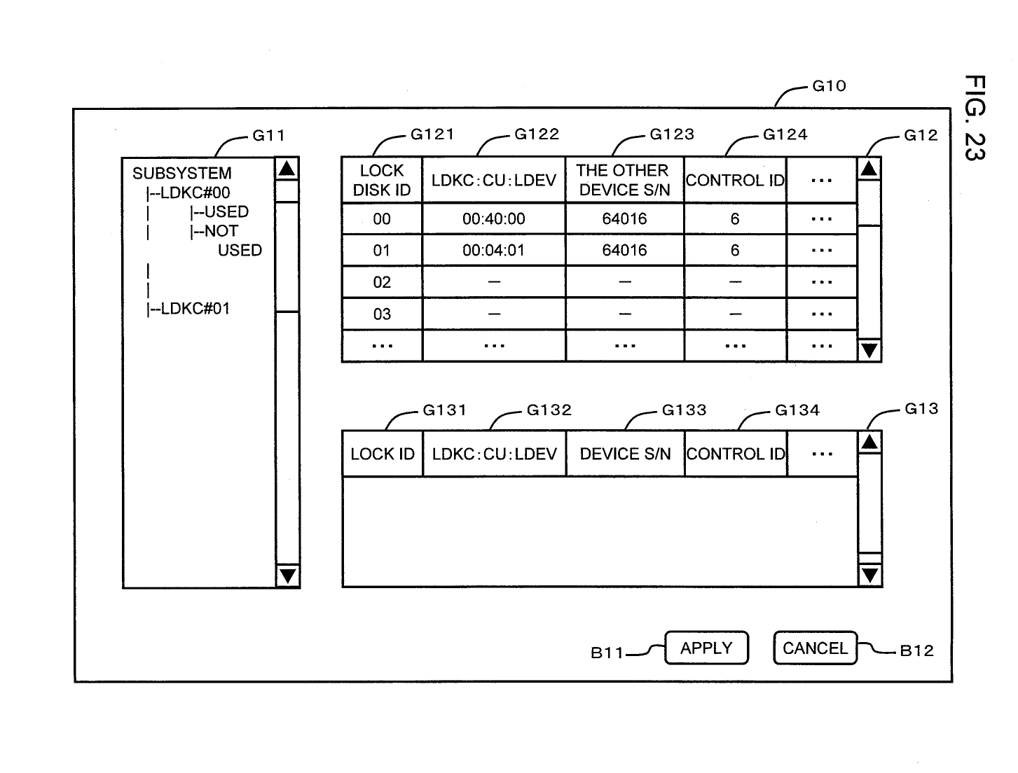

FIGS. 23 to 26 show a case in which a plurality of virtual volumes 231 is associated with one lock disk 232. As shown in the lock disk management table T10 of FIG. 23, two lock disks 232 of the lock disk IDs “00” and “01” are created for instance.

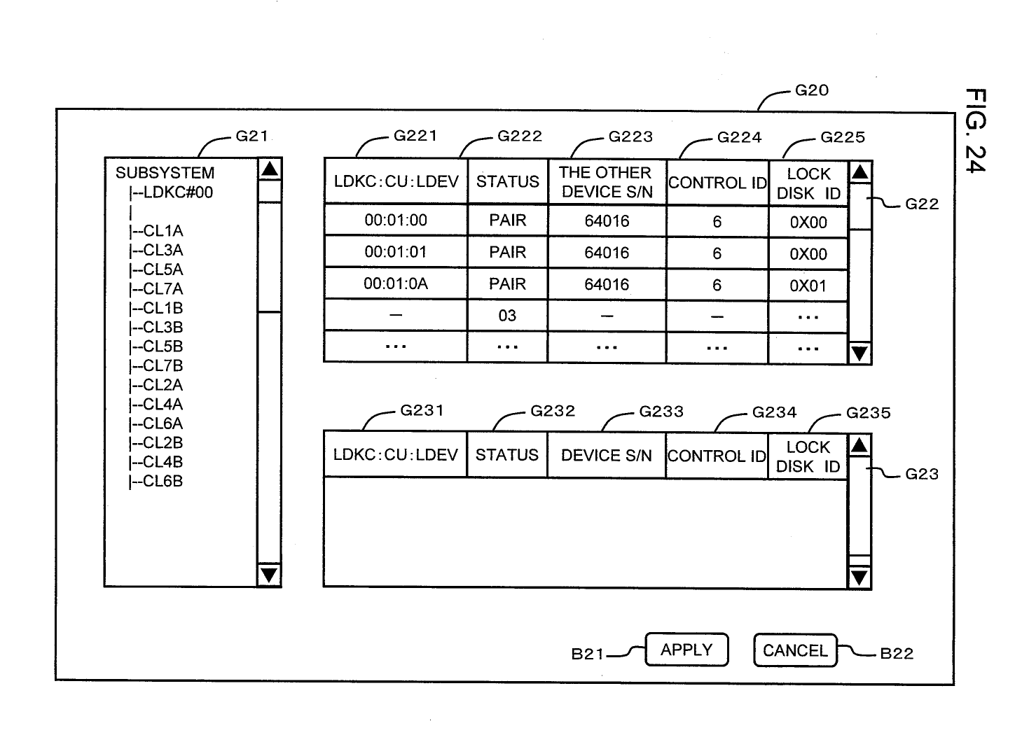

As shown in the remote copy management window G20 of FIG. 24, two remote copy pairs with the primary volume “00:01:00” and the primary volume “00:01:01” are associated with one lock disk “00”. A remote copy pair of the primary volume “00:01:0A” is associated with the other lock disk “01”.

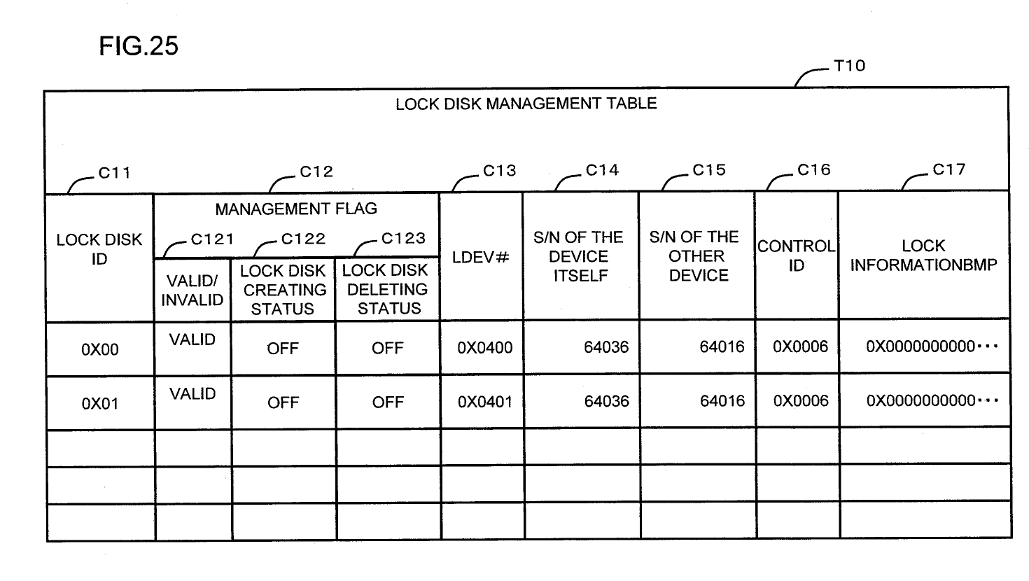

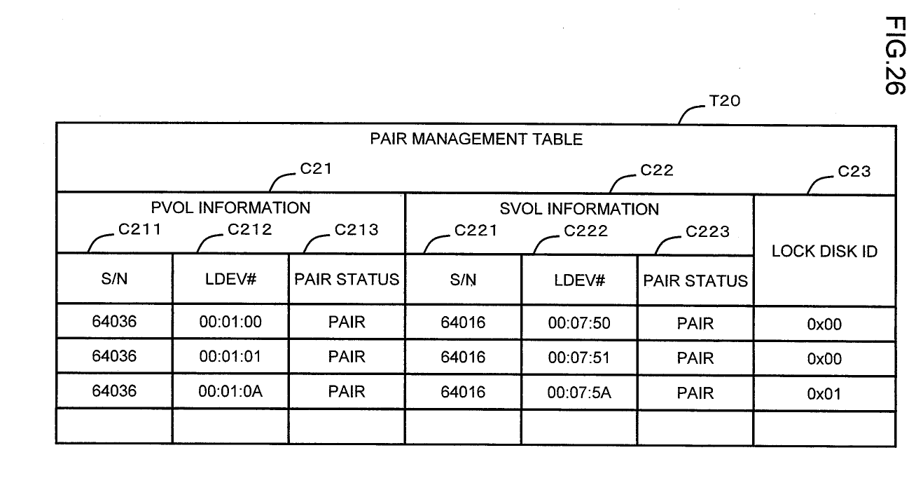

A plurality of lock disks “00” and “01” are registered to the lock disk management table T10 shown in FIG. 25. In the pair management table T20 shown in FIG. 26, two remote copy pairs are associated with one lock disk “00”, and one remote copy pair is associated with the other lock disk “01”.

In the embodiment in accordance with the present invention as described above, a plurality of virtual volumes based on the remote copy pair can be corresponded to one lock disk 232 for a management.

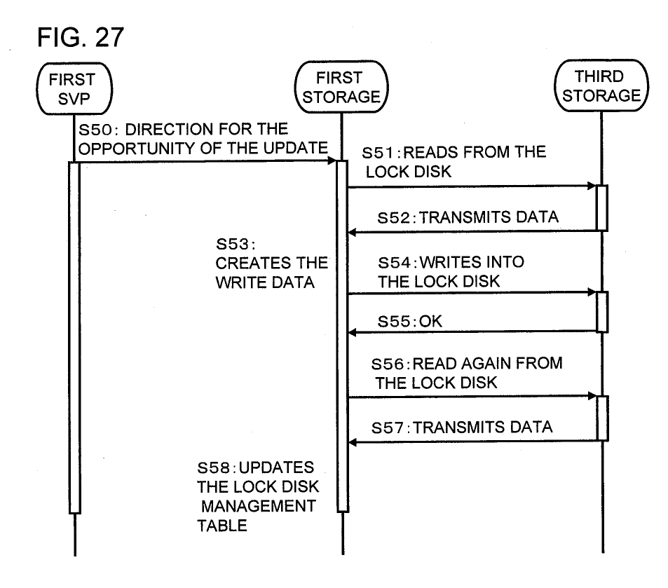

FIG. 27 is a flowchart showing a processing for updating the usage control information L10 that has been stored into the lock disk 232. As an opportunity of the update, there can be mentioned for instance the case in which a lock disk is created, the case in which a lock disk is deleted, the case in which a remote copy pair (a virtual volume, hereafter similarly) is set, the case in which a remote copy pair is deleted, the case in which a suspend is indicated to a virtual volume, the case in which a re-synch is indicated to a virtual volume, the case in which a swap suspend is indicated to a virtual volume, and the case in which a reverse re-synch is indicated to a virtual volume.

In the case in which the above opportunity of the update occurs, a prescribed direction corresponding to the opportunity of the update is input from the management server 80 to the first storage device 10 (S50). The first storage device 10 confirms whether the usage control information L10 that has been read from the lock disk 232 is left in the cache memory 130 or not. In the case in which the usage control information L10 has been stored in the cache memory 130, the first storage device 10 discards the usage control information L10. This is because the usage control information L10 that is left in the cache memory 130 may be old information.

The first storage device 10 then requests the latest usage control information L10 from the third storage device 30 (S51). The third storage device 30 transmits the usage control information L10 that has been read from the lock disk 232 to the first storage device 10 (S52).

The first storage device 10 creates the write data corresponding to the above opportunity of the update (the data for updating the usage control information L10) (S53), and transmits the write data to the third storage device 30 (S54). By this, the third storage device 30 updates the usage control information L10 that has been stored into the lock disk 232, and informs the first storage device 10 that the update has been completed (S55).

The first storage device 10 requests the transmission of the usage control information L10 from the third storage device 30 again to confirm that the update processing has been normally completed (S56). The third storage device 30 transmits the usage control information L10 that has been read from the lock disk 232 to the first storage device 10 (S57).

In the case in which the first storage device 10 confirms that the usage control information L10 has been updated correctly, the first storage device 10 updates the lock disk management table T10 (S58). As described above, the first storage device 10 can update only items related to the first storage device 10 among the usage control information L10. Consequently, the entire of the usage control information L10 can be updated in an appropriate manner by carrying out the processing shown in FIG. 27 by the second storage device 20.

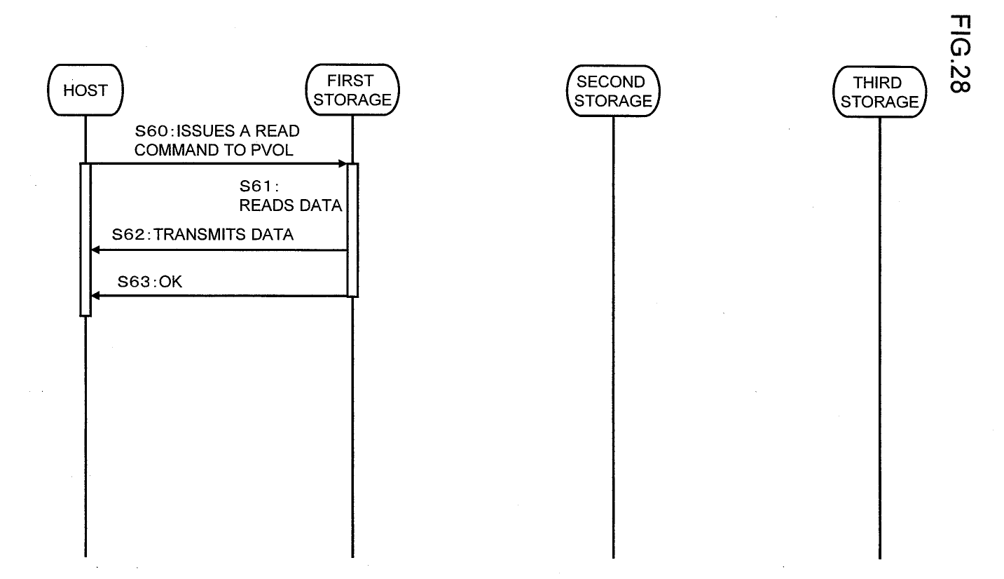

FIG. 28 is a flowchart showing a read processing for reading data from the primary volume by the host 70. The host 70 issues a read command to the first storage device 10 by using an active path (S60).

The first storage device 10 reads the requested data from the primary volume that configures the virtual volume 231 (S61), and transmits the data to the host 70 (S62). The first storage device 10 then informs the host 70 that the processing of the read command has been completed (S62).

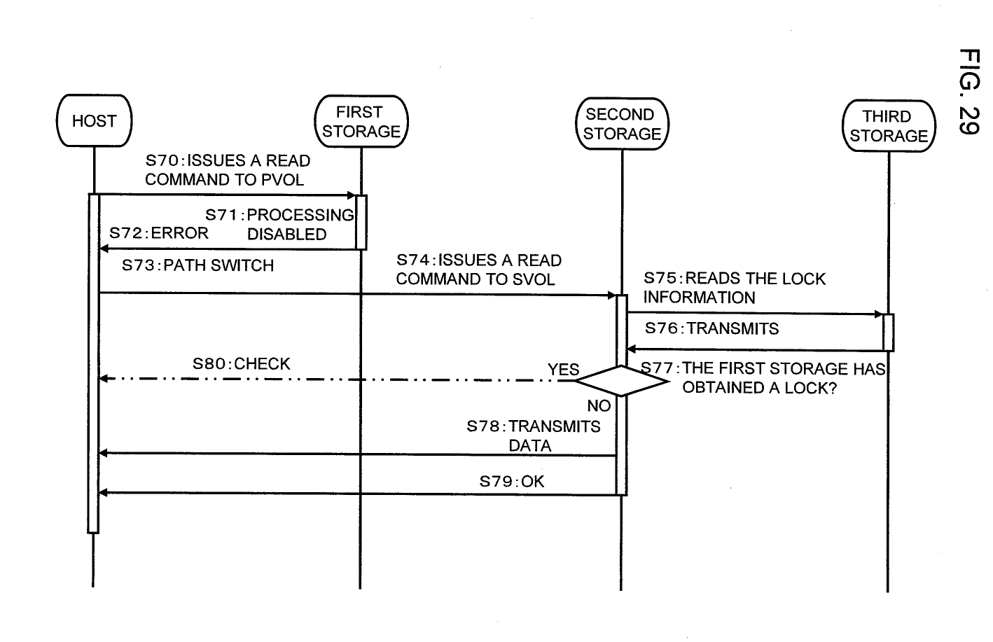

FIG. 29 is a flowchart showing a read processing for reading data from the secondary volume by the host 70. At first, the host 70 issues a read command to the first storage device 10 by using an active path (S70).

In the case in which a failure occurs in the active path that connects the host 70 and the first storage device 10 to each other, or in the case in which the first storage device 10 is stopped, the first storage device 10 cannot process the read command (S71). The path control section 78 of the host 70 detects that the first storage device 10 cannot process the read command by an error reply from the first storage device 10 or by the fact that no reply is received within a prescribed time (S72).

The path control section 78 of the host 70 then switches the active path to the passive path (S73), and issues a read command to the second storage device 20 (S74). In the case in which the second storage device 20 receives the read command from the host 70, the second storage device 20 requests the transmission of the usage control information L10 that has been stored into the lock disk 232 from the third storage device 30 (S75). Corresponding to the request from the second storage device 20, the third storage device 30 transmits the usage control information L10 that has been read from the lock disk 232 to the second storage device 20 (S76).

The second storage device 20 refers to the lock information bit map L14 of the first storage device 10 in the usage control information L10, and judges that a value of a bit corresponding to the virtual volume 231 is “1” or “0” (S77).

In the case in which a value of a bit corresponding to the virtual volume 231 is “0”, since the primary volume and the secondary volume are synchronized with each other, the second storage device 20 reads the data that has been requested from the host 70 from the secondary volume and transmits the data to the host 70 (S78). The second storage device 20 then informs the host 70 that the processing of the read command has been completed (S79).

On the other hand, in the case in which a value of a bit associated with the virtual volume 231 corresponding to the read command is “1” in the lock information bit map L14, the primary volume and the secondary volume are not synchronized with each other, and the latest data has been stored into the primary volume. In other words, the data that has been stored into the secondary volume may be old. Consequently, the second storage device 20 returns a check reply in such a manner that the host 70 does not read old data by mistake (S80).

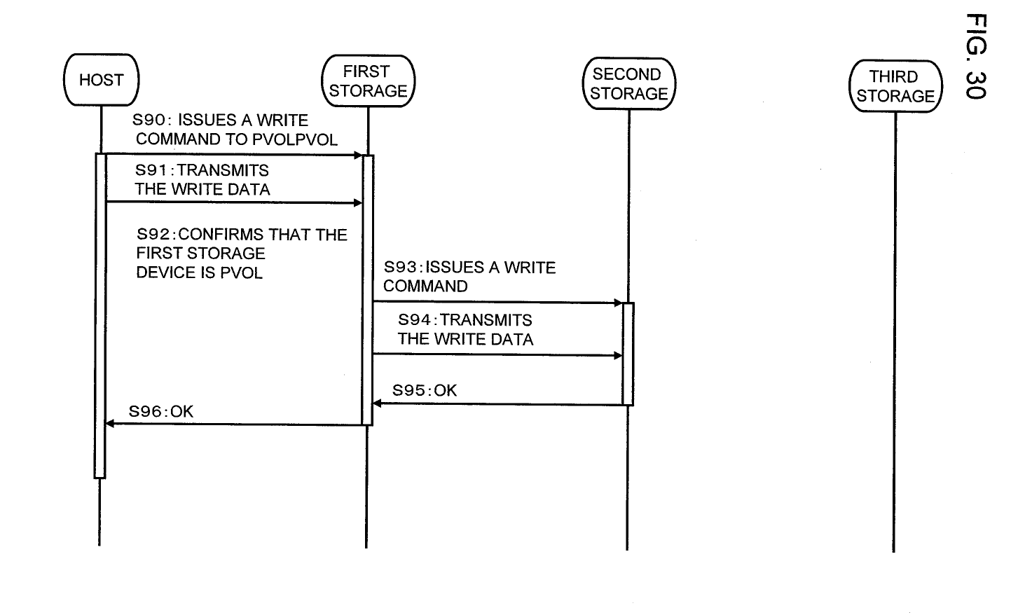

FIG. 30 is a flowchart showing a write processing for writing data to a primary volume by the host 70. The host 70 issues a write command to the first storage device 10 (S90). In the case in which the first storage device 10 receives the write command, the first storage device 10 ensures a region for storing the write data on the cache memory, and informs the host 70 that the preparation of receiving the write data has been completed. The host 70 that has received the information transmits the write data to the first storage device 10 by using an active path (S90). The write data is stored into the cache memory 130 in the first storage device 10.

The first storage device 10 confirms that the first storage device 10 is a main storage device provided with the primary volume (S92). The first storage device 10 then issues a write command to the second storage device 20 provided with the secondary volume via the inter-device communication path CN20 (S93).

In the case in which the preparation of receiving the write data has been completed, the second storage device 20 requests the transmission of the write data from the first storage device 10. The first storage device 10 that has received the request transmits the data that has received in S91 to the second storage device 20 (S94). The second storage device 20 stores the write data that has received from the first storage device 10 into the cache memory 130 in the second storage device 20, and informs the first storage device 10 that the processing has been completed (S95).

In the case in which the first storage device 10 confirms that the write data from the host 70 has been written to the secondary volume, the first storage device 10 informs the host 70 that the processing of the write command received in S90 has been completed (S96).

At the prescribed timing, the write data that has been stored into the cache memory 130 is written to the corresponding disk drive 210. A processing in which data on the cache memory is written to the disk drive and stored in the disk drive is called a destage processing. The destage processing can be carried out immediately after the write data is received (synchronous method), and can also be carried out at a separate timing from the reception of the write data (asynchronous method).

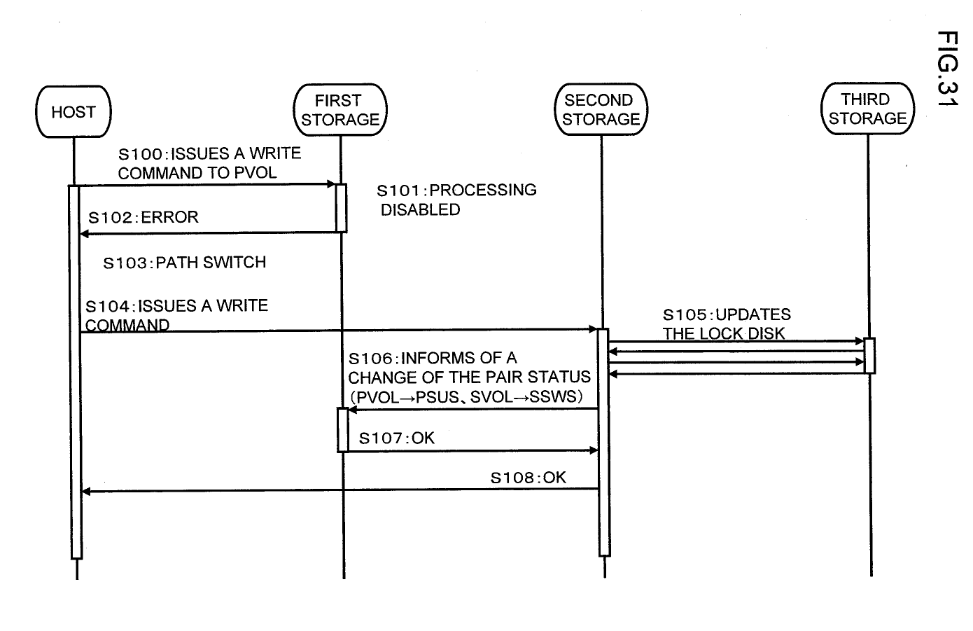

FIG. 31 is a flowchart showing a write processing for writing data to a secondary volume by the host 70. At first, the host 70 issues a write command to the first storage device 10 provided with the primary volume (S100).

However, in the case in which a failure occurs in the active path, or in the case in which the first storage device 10 is stopped, the first storage device 10 cannot process the write command (S101). In this case, the host 70 detects that a failure has occurred by an error reply from the first storage device 10 or by the time out error (S102). The path control section 78 switches the active path to the passive path (S103).

The host 70 issues a write command to the second storage device 20 by using a passive path (S104). In the case in which the preparation of receiving the write data has been completed, the second storage device 20 informs the host 70. The host 70 that has received the information transmits the write data to the second storage device 20. The second storage device 20 stores the write data that has received from the host 70 into the cache memory 130.

The second storage device 20 accesses the lock disk 232 to update the usage control information L10 (S105). The second storage device 20 sets the control information of the second storage device 20 in the usage control information L10 to “1”. By this, it is set that that the second storage device 20 is using the lock disk 232. Moreover, the second storage device 20 sets “1” to a bit corresponding to the virtual volume 231 in which the write data has been written in the lock information bit map L15 of the second storage device 20. By this, it is set that that the storage content of the secondary volume is the latest one.

As described above, in the lock disk update processing shown in S105 (the update processing of the usage control information L10), it is confirmed that the usage control information L10 has been updated correctly by reading the usage control information L10 immediately after the update. Since the similar confirming operation is carried out in each step for carrying out “the lock disk update”, the descriptions will be omitted in the following.

The second storage device 20 directs the first storage device 10 to change a pair status (S106). The status of the primary volume is changed from “pair” to “suspend (PSUS)”, and the status of the secondary volume is changed from “pair” to “swap suspend (SSWS)” (S106).

In the case in which a change of a pair status is completed, the first storage device 10 informs the second storage device 20 that the processing has been completed (S107). The second storage device 20 that has received the information then informs the host 70 that the processing of the write command has been completed (S108).

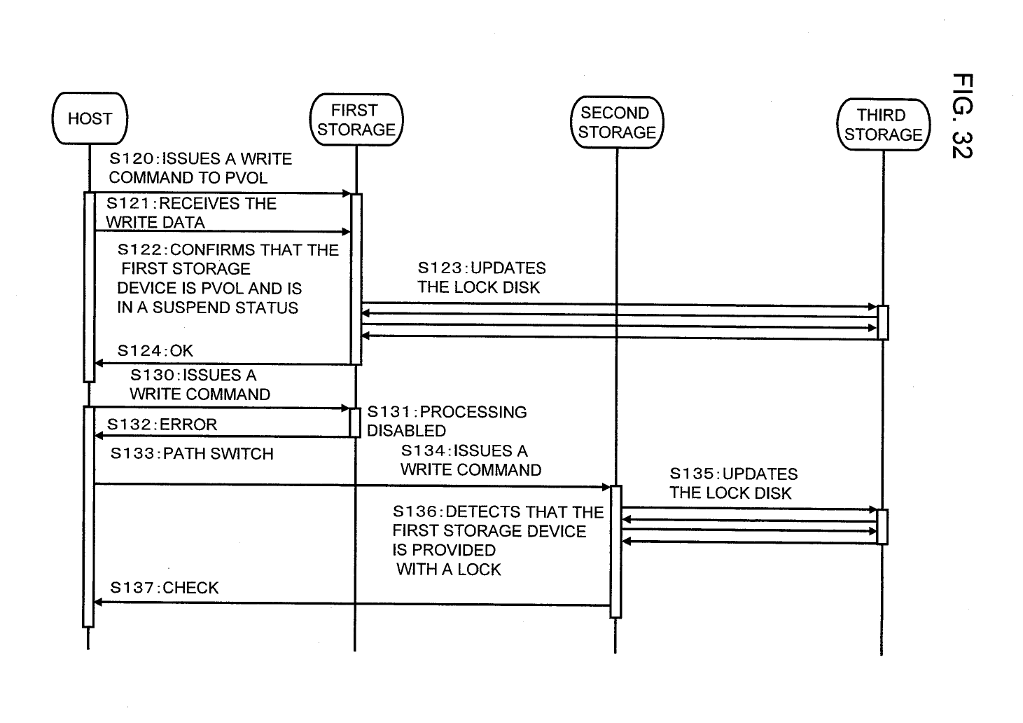

FIG. 31 shows the case in which a write processing to the secondary volume has succeeded. Next, the case in which a processing for writing data to the secondary volume fails will be described with reference to the flowchart shown in FIG. 32. In the processing shown in FIG. 32, the primary volume is operated independently. At first, the writing to the primary volume is normally carried out (S120 to S124).

The host 70 transmits a write command to the first storage device 10 provided with the primary volume (S120), and transmits the write data after confirming the preparation of receiving the write data (S121). The first storage device 10 confirms that the primary volume is operated independently (S122), and updates the usage control information L10 that has stored into the lock disk 232 (S123). Here, for instance, a value of a bit associated with the virtual volume 231 corresponding to the write command of S120 is set to be “1” in the lock information bit map L14 of the first storage device. In the case in which the update of the lock disk is completed, the first storage device 10 informs the host 70 that the processing of the write command has been completed (S124).

At a separate timing, the host 70 issues another write command the first storage device 10 (S130). Between S124 and S130, a failure occurs in the active path, or the operation of the first storage device 10 is stopped.

In this case, the first storage device 10 cannot process the write command (S131). The host 70 detects that the first storage device 10 cannot be used by an error reply or the like (S132). The path control section 78 then switches the active path to the passive path (S133).

The host 70 issues a write command to the second storage device 20 provided with the secondary volume (S134). In the case in which the status of the secondary volume is other than “swap suspend (SSWS)”, the second storage device 20 tries the update processing of the usage control information L10 that has stored into the lock disk 232 (S135).

The second storage device 20 detects that the first storage device 10 has the right to use the lock disk (the lock right) by the lock information bit map L14 of the first storage device 10 that has stored into the usage control information L10 (S136). In this case, since the storage content of the primary volume is newer than the storage content of the secondary volume, a request from the host 70 cannot be responded to using the secondary volume. Consequently, the second storage device 20 transmits a check reply to the host 70 (S137).

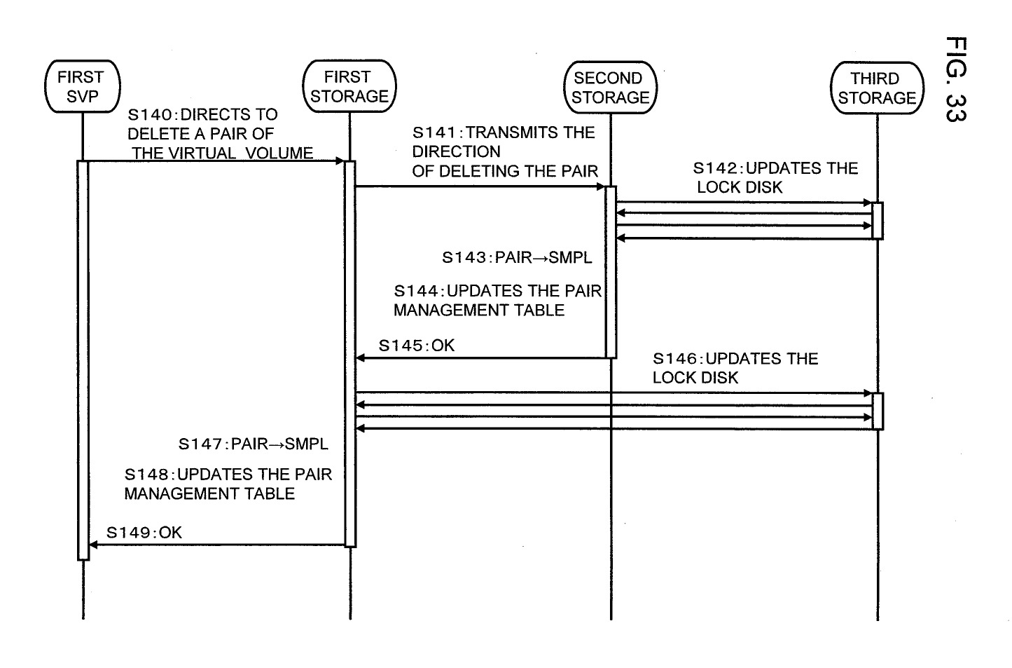

FIG. 33 is a flowchart showing a processing for deleting a remote copy pair that configures the virtual volume 231. The management server 80 directs the first storage device 10 to delete a remote copy pair that configures the virtual volume via the first SVP (S140).

The first storage device 10 refers to the pair management table T20, and confirms whether the remote copy pair to which a deletion is directed exists or not and whether the remote copy pair to which a deletion is directed can be deleted or not.

For instance, in the case in which the virtual volume 231 based on the directed remote copy pair is being used by the host 70, the remote copy pair cannot be deleted. In the case in which the directed remote copy pair does not exist, or in the case in which the directed remote copy pair cannot be deleted, the present processing is suspended.

In the case in which the specified remote copy pair exists and can be deleted, the first storage device 10 transmits the direction of deleting the remote copy pair to the second storage device 20 (S141). The second storage device 20 that has received the direction updates the usage control information L10 that has stored into the lock disk 232 (S142). The second storage device 20 sets “0” to a bit corresponding to the remote copy pair (the virtual volume) to which a deletion is directed in the lock information bit map L15 of the second storage device 20.

Moreover, the second storage device 20 changes the status of the secondary volume from “pair” to “simplex” (S143), and deletes the information related to the remote copy pair from the pair management table T20 (S144). The second storage device 20 then informs the first storage device 10 that the deletion of the remote copy pair has been completed (S145).

The first storage device 10 that has received the information accesses the lock disk 232 in the third storage device 30, and updates the usage control information L10 (S146). The first storage device 10 sets “0” to a bit corresponding to the remote copy pair to which a deletion is directed in the lock information bit map L14 of the first storage device 10.

Moreover, the first storage device 10 changes the status of the primary volume from “pair” to “simplex” (S147), and deletes the information related to the remote copy pair to which a deletion is directed from the pair management table T20 in the first storage device 10 (S148). The first storage device 10 then informs the management server 80 that the deletion of the remote copy pair has been completed (S149).

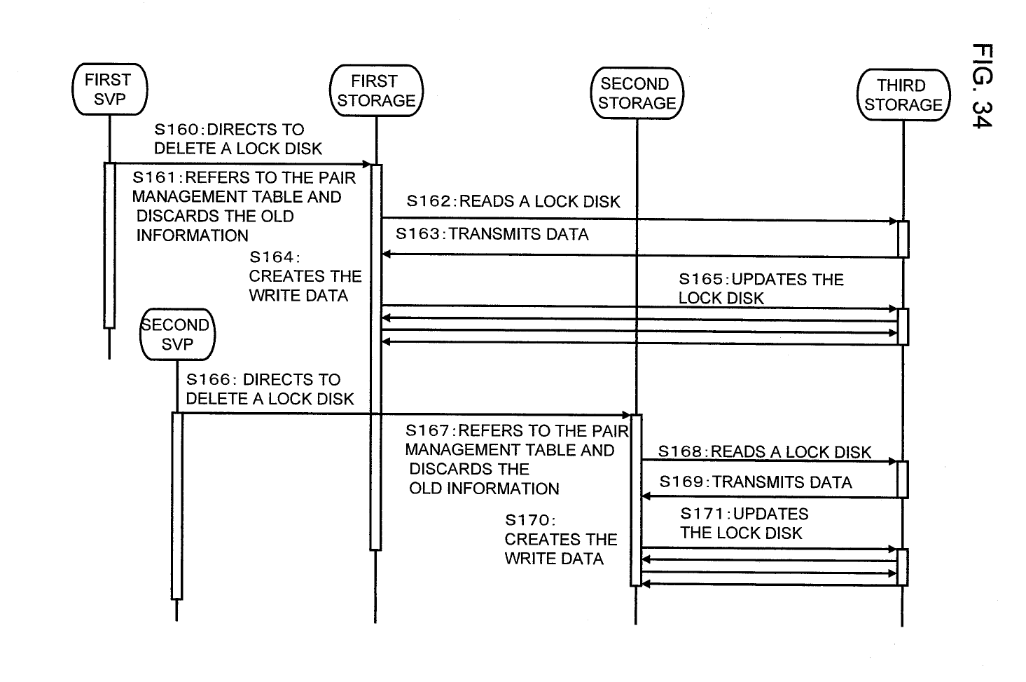

FIG. 34 is a flowchart showing a processing for deleting the lock disk 232. In the present processing, the following describes the case in which a direction from the first storage device 10 to the third storage device 30 and a direction from the second storage device 20 to the third storage device 30 do not conflict with each other.

The management server 80 directs the first storage device 10 to delete a lock disk via the first SVP (S160). The first storage device 10 refers to the pair management table T20, and confirms whether the lock disk to which a deletion is directed is used in any of the virtual volumes 231 or not (S161). In the case in which the lock disk is used in any of the virtual volumes 231, the present processing is suspended.

In the case in which the lock disk is not used, the first storage device 10 confirms whether the usage control information L10 has been stored into the cache memory 130 or not. In the case in which the usage control information L10 has already been stored into the cache memory 130, the first storage device 10 discards the usage control information L10 on the cache memory 130 since the content of the usage control information L10 that is left in the cache memory 130 may be old (S161). In S161, the pair management table T20 is referred to and the old usage control information L10 is discarded.

The first storage device 10 requests the read of the usage control information L10 from the third storage device 30 (S162). The third storage device 30 reads the usage control information L10 from the lock disk, and transmits the usage control information L10 to the first storage device 10 (S163).

After the first storage device 10 confirms whether the management information L11 in the usage control information L10 and the content of the lock disk management table T10 are equivalent to each other or not, the first storage device 10 creates the write data for updating the usage control information L10 (S164).

In the write data, the first storage device 10 changes the control information of the first storage device 10 from “1” to “0”, and returns to the status in which the first storage device 10 is not using the lock disk. Moreover, the first storage device 10 zeros out the lock information bit map L14 of the first storage device 10.

The first storage device 10 then transmits the write data that has been created as described above to the third storage device 30, and updates the usage control information L10 in the lock disk 232 (S165). The first storage device 10 deletes the information related to the deleted lock disk from the lock disk management table T10 in the first storage device 10.

Subsequently, the management server 80 directs the second storage device 20 to delete the lock disk via the second SVP (S166). The second storage device 20 refers to the pair management table T20, and confirms whether the lock disk to which a deletion is directed is used in any of the virtual volumes 231 or not (S167). Moreover, in the case in which the usage control information L10 has been stored in the cache memory 130, the second storage device 20 discards the usage control information L10 (S167).

The second storage device 20 requests the read of the usage control information L10 from the third storage device 30 (S168). The third storage device 30 transmits the usage control information L10 to the second storage device 20 (S169).

The second storage device 20 creates the write data for updating the usage control information L10 (S170) as described in the following. In the write data, the management information L11 is deleted. Since the first storage device 10 does not use a lock disk, the first storage device 10 can delete the management information L11. In the write data, the control information of the second storage device 20 is changed from “1” to “0”, and the second storage device 20 zeros out the lock information bit map L15 of the second storage device 20.

The second storage device 20 then transmits the write data to the third storage device 30, and updates the usage control information L10 (S171). By this, the lock disk is deleted.

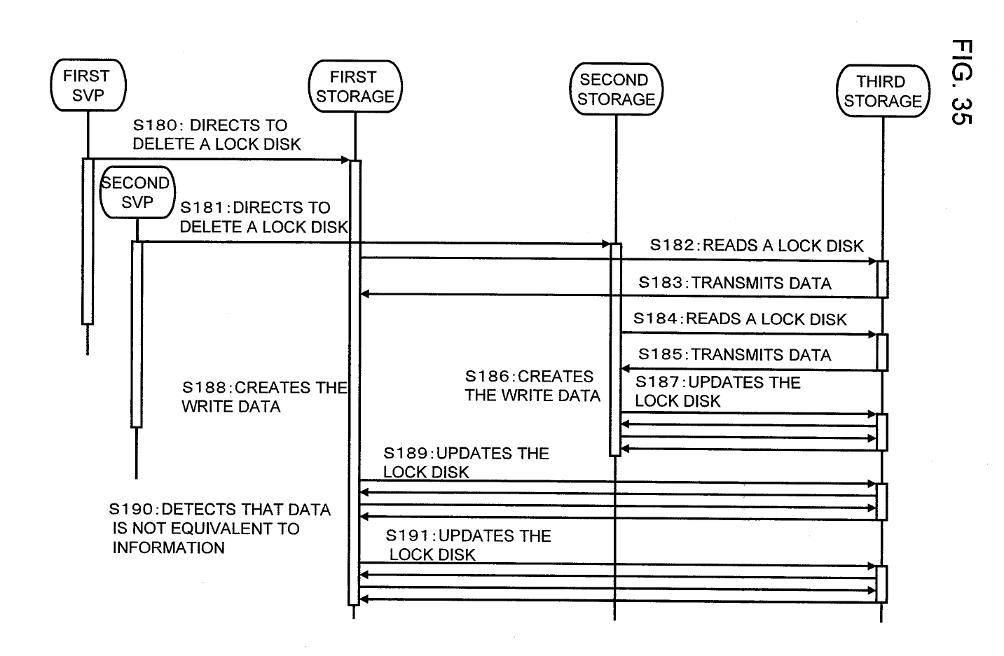

FIG. 35 is a flowchart showing a processing for deleting the lock disk. In the present processing, the following describes the case in which a direction from the first storage device 10 to the third storage device 30 and a direction from the second storage device 20 to the third storage device 30 conflict with each other. An appropriate execution order cannot be obtained in some cases depending on a degree of the congestion of a communication network and due to a delay of a reply of the storage device. In the following descriptions, a point in which the directions conflict with each other will be described mainly, and the details of the update contents of the table will be omitted.

The management server 80 directs the first storage device 10 to delete a lock disk via the first SVP (S180). Subsequently, the management server 80 directs the second storage device 20 to delete the lock disk via the second SVP (S181).

The first storage device 10 requests the transmission of the usage control information L10 from the third storage device 30 (S182). The third storage device 30 transmits the usage control information L10 to the first storage device 10 (S183). The first storage device 10 creates the write data by using the usage control information L10 that has been read (S188).

In the example shown in FIG. 35, before the first storage device 10 creates the write data and updates the usage control information L10, the second storage device 20 obtains the usage control information L10 from the third storage device 30 (S184 and S185), and creates the write data (S186). The second storage device 20 then transmits the write data that has been created to the third storage device 30, and updates the usage control information L10 (S187).

After the second storage device 20 updates the usage control information L10, the first storage device 10 transmits the write data (S188) to the third storage device 30, and updates the usage control information L10 in the lock disk (S189).

The first storage device 10 reads the usage control information L10 from the lock disk, and compares the usage control information L10 with the content of the write data to confirm whether the usage control information L10 has been updated as previously arranged or not. However, since the update processing by the second storage device 20 has been completed in advance, the write data based on the usage control information L10 that has been obtained in S182 and the usage control information L10 that has been obtained again in the processing of S189 are not equivalent to each other (S190).

The first storage device 10 then recreate the write data (S188), and updates the usage control information L10 in the lock disk by using the new write data (S191). In the write data, the management information L11 is deleted.

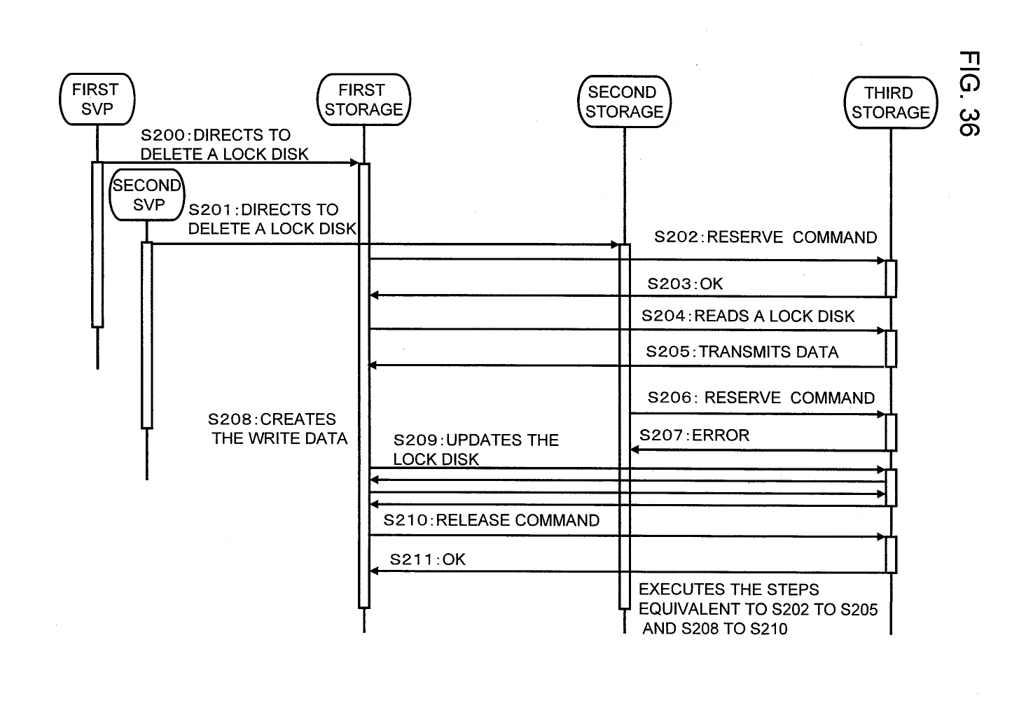

FIG. 36 is a flowchart showing an example in which the problems shown in FIG. 35 are solved by adopting a reserve command. The reserve command is a command for reserving an execution of a processing.

The management server 80 directs the first storage device 10 to delete a lock disk via the first SVP (S200). Subsequently, the management server 80 directs the second storage device 20 to delete the lock disk via the second SVP (S201).

The first storage device 10 issues a reserve command to the third storage device 30 (S202). The third storage device 30 notifies the first storage device 10 that the reserve command has been received (S203). By this, a read access and a write access from a storage device other than the first storage device 10 are prohibited for a lock disk to be deleted.

The first storage device 10 requests the transmission of the usage control information L10 from the third storage device 30 (S204). The third storage device 30 transmits the usage control information L10 to the first storage device 10 (S205).

The first storage device 10 creates the write data for deleting a lock disk based on the usage control information L10 that has been read (S208).

Before the first storage device 10 updates the usage control information L10 in the lock disk, the second storage device 20 issues the reserve command to the third storage device 30 (S206). The reserve command has already been issued from the first storage device 10 for a lock disk to be deleted (S202). Consequently, the third storage device 30 returns an error to the second storage device 20. It is necessary that the reserve command is canceled explicitly by a release command.

The first storage device 10 transmits the write data (S208) to the third storage device 30, and updates the usage control information L10 in the lock disk (S209). After the update is completed, the first storage device 10 issues a release command to the third storage device 30 (S210). In the case in which the third storage device 30 receives the release command, the third storage device 30 cancels the reserve status caused by the reserve command that has been received in S202 (S211).

After that, the second storage device 20 updates the usage control information L10 in the lock disk (S202 to S205, and 5208 to S210). By this, the lock disk is deleted.

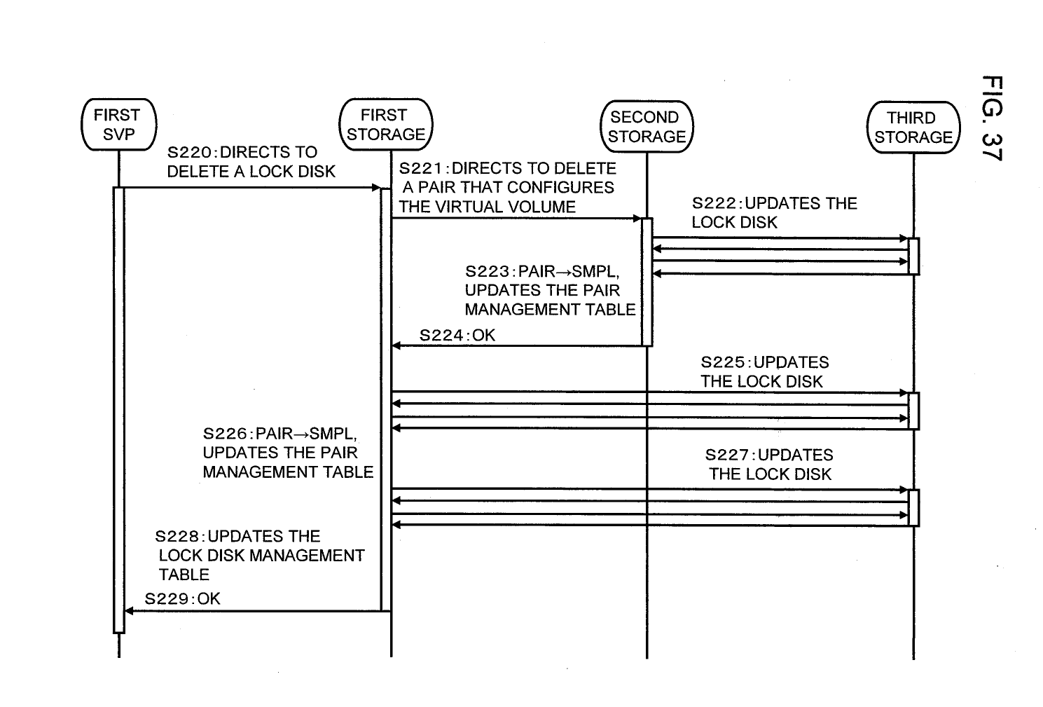

FIG. 37 shows an example in which a lock disk is deleted and a virtual volume is deleted by one direction. The management server 80 directs the first storage device 10 to delete a lock disk via the first SVP (S220).

In the case in which the first storage device 10 receives the direction of deleting the lock disk, at first, the first storage device 10 directs the second storage device 20 to delete all remote copy pairs (virtual volumes) related to the lock disk to which a deletion is directed (S221).

The second storage device 20 creates the write data for deleting a virtual volume, transmits the write data to the third storage device 30, and updates the usage control information L10 (S222). Moreover, the second storage device 20 changes the status of the secondary volume from “pair” to “simplex”, and deletes the information related to the virtual volume to be deleted from the pair management table T20 (S223). The second storage device 20 then informs the first storage device 10 that the deletion of the virtual volume on the side of the second storage device has been completed (S224).

In the case in which the first storage device 10 receives the information from the second storage device 20, the first storage device 10 creates the write data, transmits the write data to the third storage device 30, and updates the usage control information L10 in the lock disk in order to delete the virtual volume that is corresponded to the lock disk to be deleted (S225). Moreover, the first storage device 10 changes the status of the primary volume from “pair” to “simplex”, and deletes the information related to the virtual volume to be deleted from the pair management table T20 (S226).

Subsequently, the first storage device 10 creates the write data for deleting a lock disk, transmits the write data to the third storage device 30, and updates the usage control information L10 (S227). The first storage device 10 deletes the information related to the lock disk to be deleted from the lock disk management table T10 (S228). The first storage device 10 then informs the host 70 that the deletion of the lock disk has been completed (S229).

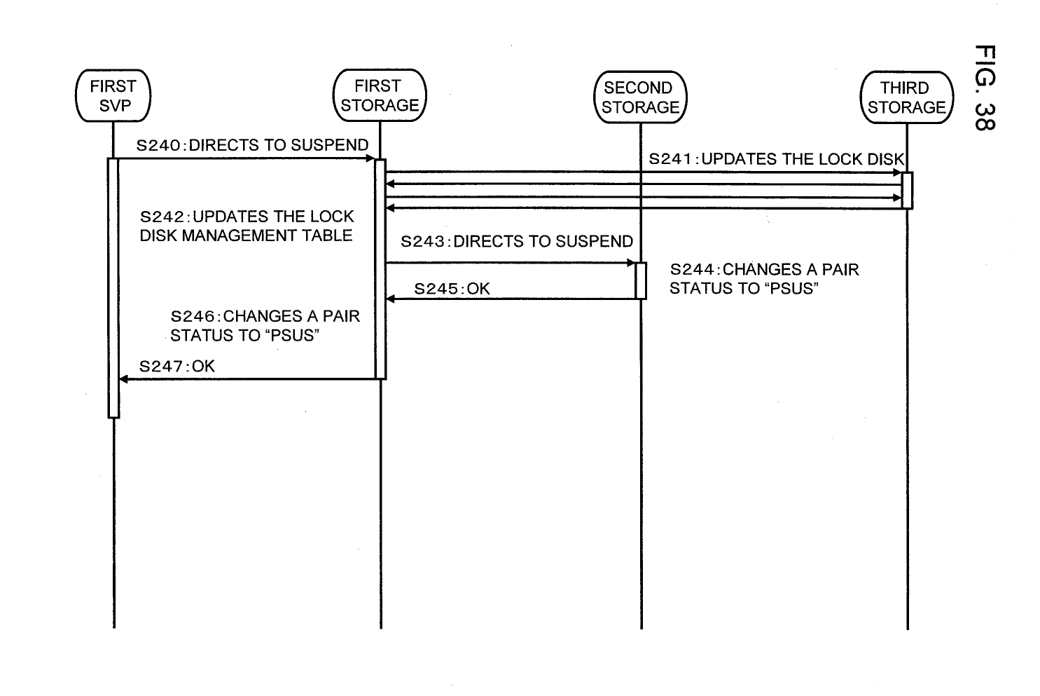

FIG. 38 is a flowchart showing the case in which the primary volume is operated independently. For instance, it is necessary to operate only the first storage device 10 in order to maintain the second storage device 20 in some cases.

The management server 80 directs the first storage device 10 to suspend via the first SVP (S240). The first storage device 10 refers to the pair management table T10, and judges whether a suspend processing is enabled or not. In the case in which a suspend processing is disabled, the present processing is suspended.

In the case in which the suspend processing is enabled, the first storage device 10 updates the usage control information L10 (S241). More specifically, the first storage device 10 sets “1” to a bit corresponding to the virtual volume related to the primary volume in the lock information bit map L14 of the first storage device 10.

The first storage device 10 updates the lock disk management table T10 (S242), and directs the second storage device 20 to migrate to a suspend status (S243). In the case in which the second storage device 20 receives the direction, the second storage device 20 changes a pair status to “PSUS” (S244), and informs the first storage device 10 that the status change has been completed (S245).

In the case in which the first storage device 10 receives the information from the second storage device 20, the first storage device 10 changes the pair status that has been stored into the pair management table T20 to “PSUS” (S246). The first storage device 10 then informs the management server 80 that the migration to a suspend status has been completed (S247).

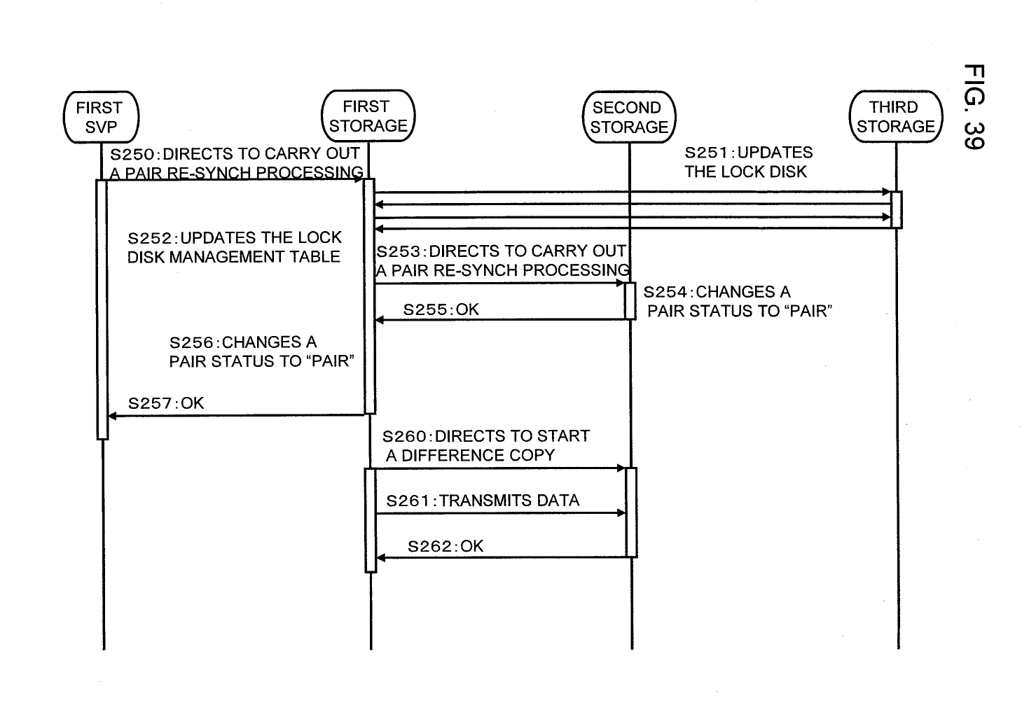

FIG. 39 is a flowchart showing a pair re-synch processing for returning from the status in which the primary volume is operated independently to the normal status. The management server 80 directs the first storage device 10 to carry out a pair re-synch processing (S250). The first storage device 10 refers to the pair management table T20, and judges whether a pair re-synch processing is enabled or not. In the case in which a pair re-synch processing is disabled, the present processing is suspended.

In the case in which a pair re-synch processing is enabled, the first storage device 10 updates the usage control information L10 (S251). More specifically, the first storage device 10 changes a corresponding bit from “1” to “0” in the lock information bit map L14 of the first storage device 10. The first storage device 10 then updates the lock disk management table T10 in the first storage device 10 (S252).

The first storage device 10 then directs the second storage device 20 to carry out a pair re-synch processing (S253). The second storage device 20 changes the status of the remote copy pair to be resynchronized to “pair” in the pair management table T20 in the second storage device 20 (S254). The second storage device 20 informs the first storage device 10 that the pair status has been changed (S255).

The first storage device 10 changes the status of the remote copy pair to be resynchronized to “pair” in the pair management table T20 in first storage device 10 (S256). The first storage device 10 informs the management server 80 that the pair re-synch processing has been completed (S257).

After that, the storage content of the primary volume and the storage content of the secondary volume are resynchronized with each other at a timing separate from the change of the pair status. A location of the data that has been updated by the host 70 while the primary volume is operated independently is managed by a difference bit map. The difference bit map is the information for managing a difference that has been generated between the storage content of the primary volume and the storage content of the secondary volume.

The first storage device 10 then directs the second storage device 20 to start a difference copy (S260). The first storage device 10 transmits the difference data to the second storage device 20 by using the difference bit map (S261). The second storage device 20 writes the difference data that has been received from the first storage device 10 into the secondary volume. In the case in which the difference copy is completed, the second storage device 20 informs the first storage device 10 that the difference copy has been completed (S262).

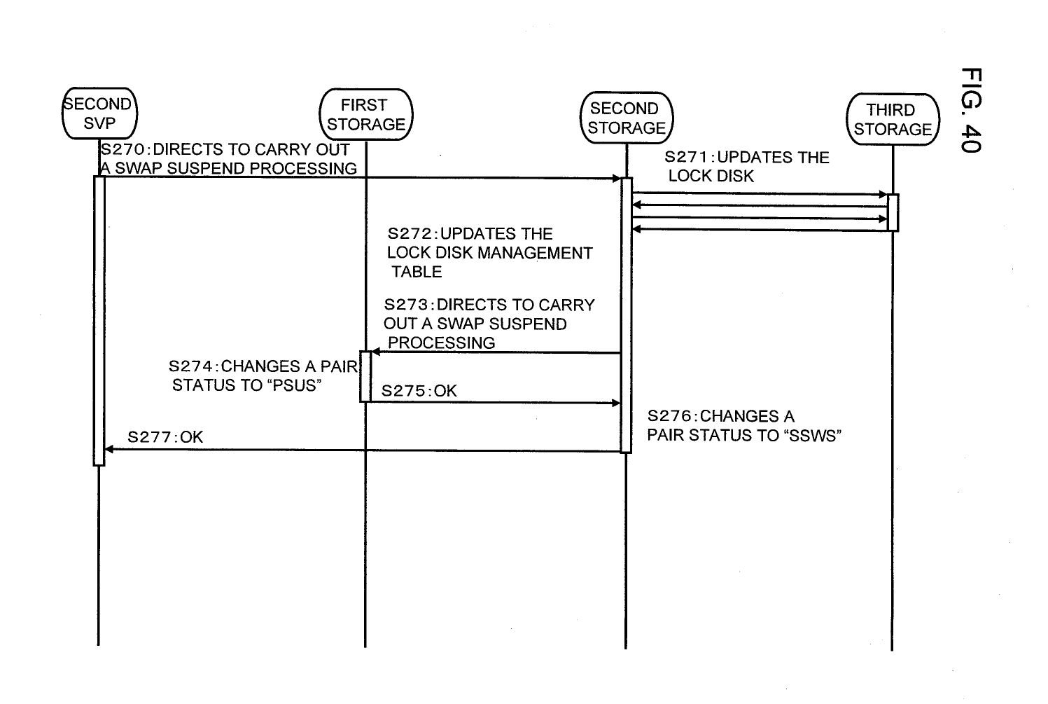

FIG. 40 is a flowchart showing the case in which the secondary volume is operated independently. For instance, only the secondary volume is operated for a maintenance work or the like in some cases. At first, the management server 80 directs the second storage device 20 via the second SVP to migrate to a swap suspend status (S270).

The second storage device 20 refers to the pair management table T20, and judges whether a swap suspend processing is enabled or not. In the case in which a swap suspend processing is disabled, the second storage device 20 accesses the lock disk 232 in the third storage device 30, and updates the usage control information L10 (S271). More specifically, the second storage device 20 sets “1” to a value of a bit corresponding to a virtual volume for a swap suspend in the lock information bit map L15 of the second storage device 20.

The second storage device 20 updates the lock disk management table T10 for the item C17 (S272), and informs the first storage device 10 of a migration to a swap suspend status (S273).

The first storage device 10 changes a pair status of the primary volume in the pair management table T20 included in the first storage device to “PSUS (suspend)” (S274), and informs the second storage device 20 that the status change has been completed.

In the case in which the second storage device 20 receives the information from the first storage device 10, the second storage device 20 changes the pair status of the secondary volume in the pair management table T20 included in the second storage device to “SSWS (swap suspend)” (S275). The second storage device 20 then informs the management server 80 that the migration to a swap suspend status has been completed (S277).

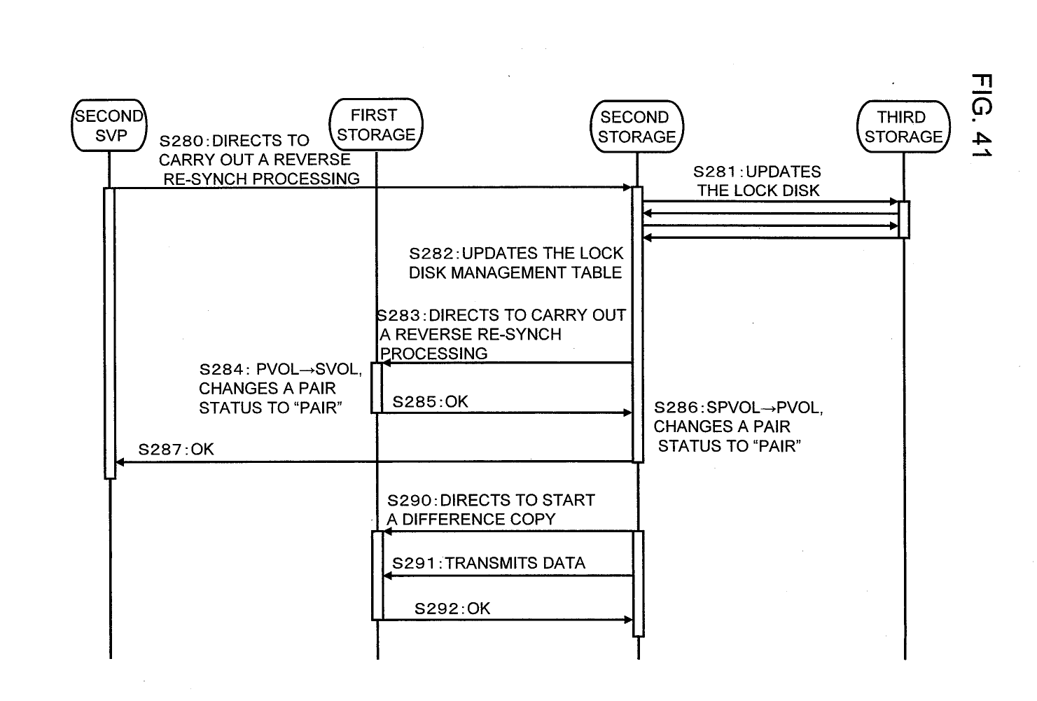

FIG. 41 is a flowchart showing a processing for returning from the status in which the secondary volume is operated independently to the normal remote copy pair status.

The management server 80 directs the second storage device 20 to carry out a reverse re-synch processing (S280). The second storage device 20 refers to the pair management table T20, and judges whether a reverse re-synch processing is enabled or not. In the case in which a reverse re-synch processing is enabled, the second storage device 20 updates the usage control information L10 in the lock disk 232 (S281). The second storage device 20 sets “0” to a value of a bit corresponding to a volume for a reverse re-synch processing in the lock information bit map L15 of the second storage device 20.

The second storage device 20 updates the lock disk management table T10 (S282), and informs the first storage device 10 of an execution of a reverse re-synch processing (S283). The first storage device 10 changes the primary volume to the secondary volume and changes a pair status to “PAIR” in the pair management table T20 (S284). The first storage device 10 informs the second storage device 20 that the change has been completed (S285).

The second storage device 20 changes the secondary volume to the primary volume and changes a pair status to “PAIR” in the pair management table T20 (S286). In other words, the primary volume and the secondary volume are switched to each other by changing the primary volume to the secondary volume (S284) and by changing the secondary volume to the primary volume (S286).

The second storage device 20 informs the management server 80 that the reverse re-synch processing has been completed (S287). At a separate timing, the difference data is then copied from the primary volume (previous secondary volume) to the secondary volume (previous primary volume).

The second storage device 20 that has been changed to the main storage device informs the first storage device 10 that has been changed to the sub storage device of an execution of a difference copy (S290). The second storage device 20 transmits the difference data to the first storage device 10 (S291). After the first storage device 10 stores the difference data into the cache memory 130, the first storage device 10 writes the difference data into the secondary volume. The second storage device 20 informs the first storage device 10 that the difference copy has been completed (S292).

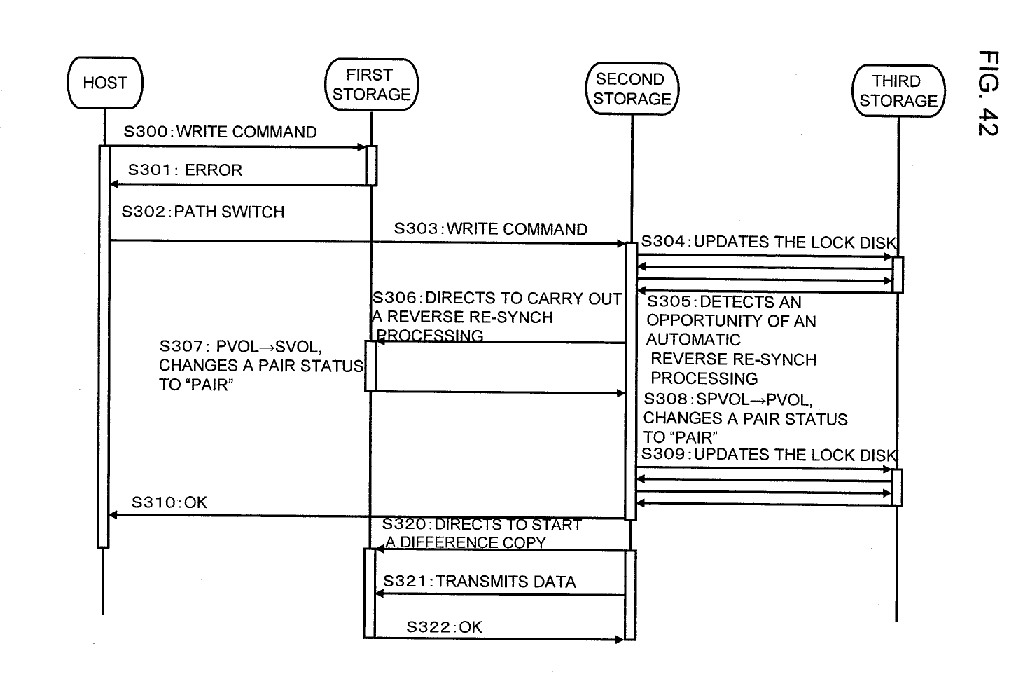

FIG. 42 is a flowchart showing a processing for automatically carrying out a reverse re-synch in the case in which a prescribed opportunity presents itself. In the case of FIG. 41, a user manually directs to carry out a reverse re-synch from the management server 80. On the other hand, in the processing shown in FIG. 42, a reverse re-synch is automatically carried out after a migration of the swap suspend for instance.

The host 70 issues a write command to the primary volume in the first storage device 10 (S301). However, the first storage device 10 cannot process the write command due to a failure or the like, and an error reply is returned (S302).

The path control section 78 of the host 70 then switches the active path to the passive path (S303), and issues a write command to the secondary volume in the second storage device 20 (S304).

The second storage device 20 updates the usage control information L10 in the lock disk and migrates to the swap suspend status (S304). The write data is written to only the secondary volume. After the second storage device 20 writes the write data into the secondary volume, the second storage device 20 informs the host 70 that the processing has been completed (not shown).

After the swap suspend status is migrated, the second storage device 20 judges whether an opportunity of carrying out a reverse re-synch presents itself or not. In the case in which the second storage device 20 detects that an opportunity of carrying out a reverse re-synch presents itself (S305), the second storage device 20 carries out a reverse re-synch (S306 to S322).

As an opportunity of carrying out a reverse re-synch, there can be mentioned for instance timing immediately after a migration to the swap suspend status, timing after a prescribed time has elapsed from a migration to the swap suspend status, and timing after a heartbeat communication is restarted from a migration to the swap suspend status.

The second storage device 20 informs the first storage device 10 of an execution of a reverse re-synch processing (S306). The first storage device 10 that has received the information changes the primary volume to the secondary volume and changes a pair status to “PAIR” in the pair management table T20 (S307).

In the case in which the second storage device 20 confirms that the change has been completed on the side of the first storage device 10, the second storage device 20 changes the secondary volume to the primary volume and changes a pair status to “PAIR” in the pair management table T20 (S308). The second storage device 20 updates the usage control information L10 in the lock disk and changes a corresponding bit in the lock information bit map L15 to “0” (S309). The second storage device 20 informs the host 70 that the reverse re-synch processing has been completed (S310).

At a separate timing, the second storage device 20 informs the first storage device 10 of an execution of a difference copy (S320). The second storage device 20 then transmits the difference data to the first storage device 10 (S321). After the first storage device 10 stores the difference data into the cache memory 130, the first storage device 10 informs the second storage device 20 that the difference copy has been completed (S322).

The embodiment in accordance with the present invention that is configured as described above has the following effects. In the embodiment in accordance with the present invention, the lock disk 232 is formed in the third storage device 30 that is separate from the first storage device 10 and the second storage device 20, and the usage control information L10 for controlling a usage of the virtual volume 231 that is configured by the primary volume and the secondary volume is stored into the lock disk 232. Consequently, the storage devices 10 and 20 can appropriately carry out a switch between the storage devices 10 and 20 by sharing the lock disk 232. Therefore, it is not necessary for the host 70 to be conscious of a switch between the storage devices 10 and 20.

In the embodiment in accordance with the present invention, the management information L11 of the usage control information L10 includes the lock disk ID L111 and the identification information L112 and L113 for specifying the first storage device 10 and the second storage device 20. In other words, in the embodiment in accordance with the present invention, total three of information of the lock disk ID and the production number of each storage device can be associated with each other for a management, and a failure in which the lock disk 232 is associated with other storage device can be prevented from occurring.

In the embodiment in accordance with the present invention, the lock disk 232 that is configured as an external volume is corresponded to an external connection volumes that are formed virtually in the storage devices 10 and 20. Consequently, the storage resource of the third storage device 30 can be used.

In the embodiment in accordance with the present invention, a user can direct the storage device to set a virtual volume, a lock disk, and an external connection from the management server 80. Consequently, usability can be improved.

In the embodiment in accordance with the present invention, the first storage device 10 can update only the information related to the first storage device 10 among the usage control information L10. Similarly, the second storage device 20 can update only the information related to the second storage device 20 among the usage control information L10. Consequently, it can be prevented from occurring that the first storage device 10 rewrites the information related to the second storage device 20 by mistake, and in reverse, that the second storage device 20 rewrites the information related to the first storage device 10 by mistake, thereby improving reliability.

In the embodiment in accordance with the present invention, in the case in which the usage control information L10 is updated, the usage control information L10 is read from the lock disk 232 immediately after the update, and it is confirmed whether the usage control information L10 has been updated correctly or not. Consequently, even in the case in which the separate storage devices 10 and 20 share one lock disk 232, it can be ensured that the usage control information L10 is updated appropriately, thereby improving the reliability of the storage system.

In the embodiment in accordance with the present invention, in the case in which the lock disk 232 is deleted, a virtual volume 231 related to the lock disk 232 can also be deleted by one direction. By this, usability of a user can be improved.

In the embodiment in accordance with the present invention, in the case in which a prescribed execution opportunity is detected after a swap suspend is migrated to, a reverse re-synch can also be carried out automatically. Consequently, usability of a user can be improved.

While the preferred embodiments in accordance with the present invention have been described above, the present invention is not restricted to the embodiments, and a person having ordinary skill in the art can carry out various changes, modifications, and functional additions without departing from the scope of the present invention.

1. A storage system provided with a host computer, a plurality of storage control devices that are used by the host computer, and a management device for managing the storage control devices, which are connected to each other so as to enable the communication with each other,
wherein the plurality of storage control devices include a first storage control device, a second storage control device, and a third storage control device,
the storage system comprising a virtual volume setting section that creates a virtual volume by setting a first volume included in the first storage control device and a second volume included in the second storage control device as a pair and provides the created virtual volume to the host computer; and
a control volume setting section that sets a third volume included in the third storage control device as a control volume that stores the usage control information for controlling a usage of the virtual volume,
wherein the usage control information that is stored into the third volume includes the identification information for specifying the first storage control device and the second storage control device.

2. The storage system as defined in claim 1, wherein:
the host computer is connected to the first storage control device and the second storage control device via a first communication path, the first storage control device and the second storage control device are connected to each other via a second communication path, the third storage control device is connected to the first storage control device and the second storage control device via a third communication path, the management device is connected to the host computer, the first storage control device, the second storage control device, and the third storage control device via a fourth communication path,
the first storage control device is provided with a first management section (a first SVP), the first volume, and a fourth volume virtually formed,
the second storage control device is provided with a second management section (a second SVP), the second volume, and a fifth volume virtually formed,
the management device is provided with:
(1) the virtual volume setting section that creates the virtual volume by giving a prescribed instruction to the first management section and the second management section and provides the created virtual volume to the host computer;
(2) the control volume setting section that sets the third volume as the control volume by giving another prescribed instruction to the first management section and the second management section; and
(3) a corresponding setting section that corresponds the fourth volume and the fifth volume to the third volume by giving other prescribed instruction to the first management section and the second management section,
the usage control information includes a third volume identification information for specifying the third volume, a first identification information for specifying the first storage control device, a second identification information for specifying the second storage control device, a first usage information for indicating whether the first storage control device uses the third volume or not, a second usage information for indicating whether the second storage control device uses the third volume or not, a first difference generation information for indicating that difference data is generated in the first volume after the pair is canceled, and a second difference generation information for indicating that difference data is generated in the second volume after the pair is canceled,
only the first storage control device can update the first identification information, the first usage information, and the first difference generation information,
only the second storage control device can update the second identification information, the second usage information, and the second difference generation information, and
only the first storage control device and the second storage control device that are made to correspond to the usage control information can use the third volume, and other storage control devices having identification information other than identification information included in the usage control information cannot use the third volume.

3. The storage system as defined in claim 1, further comprising a corresponding setting section that corresponds a virtual fourth volume formed in the first storage control device to the third volume and that corresponds a virtual fifth volume formed in the second storage control device to the third volume,
wherein the first storage control device uses the third volume via the fourth volume, and the second storage control device uses the third volume via the fifth volume.

4. The storage system as defined in claim 3, wherein only the first storage control device and the second storage control device can use the third volume, and other storage control devices having identification information other than identification information included in the usage control information cannot use the third volume.

5. The storage system as defined in claim 1, wherein the virtual volume setting section and the control volume setting section are disposed in the management device.

6. The storage system as defined in claim 3, wherein the virtual volume setting section, the control volume setting section, and the corresponding setting section are disposed in the management device.

7. The storage system as defined in claim 1, wherein the usage control information includes a region that can be updated by only the first storage control device and a region that can be updated by only the second storage control device.

8. The storage system as defined in claim 1, wherein the usage control information includes a third volume identification information for specifying the third volume, a first identification information for specifying the first storage control device, a second identification information for specifying the second storage control device, a first usage information for indicating whether the first storage control device uses the third volume or not, a second usage information for indicating whether the second storage control device uses the third volume or not, a first difference generation information for indicating that difference data is generated in the first volume after the pair is canceled, and a second difference generation information for indicating that difference data is generated in the second volume after the pair is canceled,

9. The storage system as defined in claim 8, wherein only the first storage control device can update the first identification information, the first usage information, and the first difference generation information, and only the second storage control device can update the second identification information, the second usage information, and the second difference generation information.

10. The storage system as defined in claim 1, wherein, in the case in which the usage control information is updated, the usage control information is read from the third volume to confirm whether the usage control information is updated correctly or not.

11. The storage system as defined in claim 1, wherein the first storage control device is provided with a first management table corresponding to the usage control information, the second storage control device is provided with a second management table corresponding to the usage control information, and the first management table and the second management table are updated corresponding to the update of the usage control information.

12. The storage system as defined in claim 1, wherein, in the case in which a difference is generated between the first volume and the second volume, the virtual volume setting section resynchronizes the storage content of the first volume and the storage content of the second volume so as to cancel the difference based on a prescribed opportunity.

13. The storage system as defined in claim 1, wherein, in the case in which the pair related to the virtual volume is deleted, the control volume setting section deletes the usage control information related to the virtual volume after the virtual volume setting section deletes the pair.

14. A method for controlling the storage system provided with a host computer, a plurality of storage control devices that are used by the host computer, and a management device for managing the storage control devices, which are connected to each other so as to enable the communication with each other,
wherein the plurality of storage control devices include a first storage control device, a second storage control device, and a third storage control device,
the method for controlling the storage system comprising the steps of:
creating a virtual volume that is provided to the host computer by setting a first volume included in the first storage control device and a second volume included in the second storage control device as a pair;
setting a third volume included in the third storage control device as a control volume that stores the usage control information for controlling a usage of the virtual volume; and
including the identification information for specifying the first storage control device and the second storage control device in the usage control information that is stored into the third volume,
wherein the steps are executed based on an instruction that is sent from the management device to the first storage control device and the second storage control device.
